(19) United States
(12) Patent Application Publication
(10) Pub. No.: US 2013/0071630 A1
(43) Pub. Date: Mar. 21, 2013

(54) FIBROUS STRUCTURES DERIVED FROM RENEWABLE RESOURCES

(71) Applicant: Paul Thomas Weisman, Cincinnati, OH (US)

(72) Inventor: Paul Thomas Weisman, Cincinnati, OH (US)

(21) Appl. No.: 13/236,150

(22) Filed: Sep. 19, 2011

(51) Int. Cl. B32B 3/00; D02G 3/00

(52) U.S. Cl. 428/195.1; 428/373

(57) ABSTRACT

Disclosed herein are co-formed fibrous structures that are composed of (a) a plurality of filaments that have a biobased content of at least about 25% and selected from the group consisting of polypropylene, polyethylene, polymethylpentene, polybutylene-1, polyisobutylene, ethylene propylene copolymer, ethylene propylene diene monomer copolymer or rubber, and mixtures thereof; and, (b) a solid additive including a cellulosic fiber. The solid additive is present in an amount of at least about 30 wt. %, based on the total weight of the fibrous structure. The co-formed fibrous structures of the invention can themselves be articles, such as, paper, fabrics, and absorbent pads.

### FIELD OF THE INVENTION

The invention relates to co-formed fibrous structures composed of filaments that are derived from renewable resources. In particular, the invention relates to co-formed fibrous structures that have filaments that are at least partially composed of bio-polyolefin (e.g., polypropylene). The co-formed fibrous structures of the invention can themselves be articles, such as, paper, fabrics, and absorbent pads.

### BACKGROUND OF THE INVENTION

Fibrous structures include an orderly arrangement of one or more of filaments and/or fibers, and are used to perform a variety of functions. For example, fibrous structures can be used to form paper, fabrics (e.g., woven, knitted, and non-woven), wipes, and absorbent pads (e.g., for diapers or feminine hygiene products). Co-formed fibrous structures (“co-forms”) are fibrous structures that include a mixture of two different materials. At least one of the materials of a co-form includes a filament, and at least one other material, which is different from the first material, includes a solid additive, such as a fiber, a particulate (e.g., a granular substance or a powder), or a mixture thereof. Filaments and fibers are both elongate particulates with a length to diameter ratio of at least about 10. A filament has a length of at least about 2 inches and is typically considered continuous or substantially continuous in nature, while a fiber has a length of less than about 2 inches and is typically considered discontinuous in nature.

Most of the polymers used as the filaments of fibrous structures, such as polypropylene and polyethylene, are derived from monomers (e.g., ethylene and propylene) that are obtained from non-renewable, fossil-based resources (e.g., petroleum, natural gas, and coal). As used herein, “petroleum” refers to crude oil and its components of paraffinic, cycloparaffinic, and aromatic hydrocarbons. Crude oil may be obtained from tar sands, bitumen fields, and oil shale. Thus, the price and availability of the petroleum, natural gas, and coal feedstock ultimately have a significant impact on the price of polymers used for fibrous structures. As the worldwide price of petroleum, natural gas, and/or coal escalates, so does the price of fibrous structures. Furthermore, many consumers display an aversion to purchasing products that are derived from petrochemicals. In some instances, consumers are hesitant to purchase products made from limited non-renewable resources (e.g., petroleum, natural gas and coal). Other consumers may have adverse perceptions about products derived from petrochemicals as being “unnatural” or not environmentally friendly.

Polymers derived from renewable resources, such as starch, starch derivatives, cellulose, cellulose derivatives, hemicellulose, hemicellulose derivatives, polylactic acid filaments, and polyhydroxyalkanoate filaments, have been used as the filaments of fibrous structures. Fibrous structures composed of the aforementioned filaments, however, may exhibit one or more undesirable properties with respect to manufacture, stability, and performance (e.g., inability to withstand the manufacturing process, and/or short shelf life).

Accordingly, it would be desirable to provide fibrous structures that are composed of filaments that are derived from renewable resources, and that also include desirable properties with respect to manufacture, stability, and performance.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 illustrates that the fibrous structures described herein comprise a combination of Liquid Absorptive Capacity and Soil Leak Through;

FIG. 2 illustrates that the pore volume distributions of the fibrous structures described herein;

FIG. 3 illustrates a schematic representation of an example of a fibrous structure described herein;

FIG. 4 illustrates a schematic representation of an example of a fibrous structure described herein;

FIG. 5 illustrates a cross-sectional, SEM microphotograph of a fibrous structure described herein;

FIG. 6 illustrates a layered fibrous structure described herein;

FIG. 7 illustrates a cross-sectional schematic representation of a layered fibrous structure;

FIG. 8 illustrates a fibrous structure comprising a filament-containing fibrous structure such that the filament-containing fibrous structure, such as a polysaccharide filament fibrous structure, such as a starch filament fibrous structure, is positioned between two fibrous structures 50 or two finished fibrous structures;

FIG. 9 illustrates an example of a method for making a fibrous structure described herein;

FIG. 10 illustrates a patterned belt that comprises a reinforcing structure, such as a fabric 54, upon which a polymer resin 56 is applied in a pattern;

FIG. 11 illustrates a die that comprises a filament-forming hold position within a fluid-releasing hole;

FIG. 12 illustrates a fibrous structure with a thermal bonded pattern;

FIG. 13 illustrates fibrous structures that are Z-folded and placed in a stack to a height of 82 mm;

FIGS. 14 and 14A are diagrams of a support rack utilized in the VFS Test Method described herein; and

FIGS. 15 and 15A are diagrams of a support rack cover utilized in the VFS Test Method described herein.

### SUMMARY OF THE INVENTION

In one aspect, the invention provides a co-formed fibrous structure that is composed of (a) a plurality of filaments that have a biobased content of at least about 25% and/or at least about 35% and/or at least about 45% and/or at least about 50% and/or at least about 70% and/or at least about 75% and/or at least about 85% and/or at least about 90% and/or at least about 95%, for example, about 97%, about 99%, or about 100%, and are selected from the group consisting of polypropylene, polyethylene, polymethylpentene, polybutene-1, polyisobutylene, ethylene propylene copolymer, ethylene propylene diene monomer copolymer or rubber, and mixtures thereof; and, (b) a solid additive comprising a cellulose fiber. The solid additive is present in an amount of at least about 30 wt. %, based on the total weight of the fibrous structure. The solid additive can further include a compound selected from the group consisting of a granular substance, a powder, and mixtures thereof.

In some embodiments, at least one filament is polypropylene. In some embodiments, at least one filament is a bicomponent filament. In some embodiments, at least one filament can include a hydrophilic modifier, such as a surfactant. This hydrophilic modifier can be present in an amount of up to about 20 wt. %, based on the total filament weight.

The cellulosic fiber of the co-formed fibrous structure can be derived from at least one of a mechanical pulp, a thermomechanical pulp, a chemithermomechanical pulp, a chemical pulp, a recycled pulp (e.g., post-consumer recycled and/or post-industrial recycled), bagasse, grass, and grain. In some embodiments, the cellulosic fiber is selected from the group consisting of a softwood pulp fiber, a hardwood pulp fiber, a groundwood pulp fiber, a cotton linter fiber, a sulfite pulp fiber, a sulfate pulp fiber, a rayon fiber, a lyocell fiber, and mixtures thereof. In some preferred embodiments, the cellulosic fiber is selected from the group consisting of a Southern Softwood Kraft pulp fiber, a Northern Softwood Kraft pulp fiber, a Eucalyptus pulp fiber, an Acacia pulp fiber, and mixtures thereof.

The co-formed fibrous structure can further include a secondary additive that is present in an amount of about 0.01 wt. % to about 95 wt. %, based on the total dry weight of the fibrous structure. Non-limiting examples of the secondary additive include a softening agent, a bulk softening agent, a lotion, a silicone, a latex, a surface-pattern-applied latex, a dry strength agent, a temporary wet strength agent, a permanent wet strength agent, a wetting agent, a lint reducing agent, an opacity increasing agent, an odor absorbing agent, a perfume, a temperature indicating agent, a color agent, a dye, an osmotic material, a microbial growth detection agent, an antibacterial agent, and mixtures thereof.

The co-formed fibrous structure can exhibit a pore volume distribution. In some embodiments, greater than 40% of the total pore volume present in the fibrous structure exists in pores of radii of about 121 μm to about 200 μm. In some embodiments, greater than 50% of the total pore volume present in the fibrous structure exists in pores of radii of about 101 μm to about 200 μm. In some embodiments, the co-formed fibrous structure can exhibit at least a bi-modal pore volume distribution, where greater than about 2% of the total pore volume exists in pores of radii of less than 100 μm, and either greater than 40% of the total pore volume present in the fibrous structure exists in pores of radii of about 121 μm to about 200 μm or greater than 50% of the total pore volume present in the fibrous structure exists in pores of radii of about 101 μm to about 200 μm.

In some embodiments, the fibrous structure is embossed, printed, tuft-generated, thermally bonded, ultrasonic bonded, perforated, surface treated, or mixtures thereof.

The co-formed fibrous structure itself can be an absorbent pad, a paper, or a fabric. The absorbent pad can be selected from the group consisting of a sanitary tissue, a sanitary napkin, a diaper, and a wipe, for example a wet wipe. The sanitary tissue can be selected from the group consisting of a toilet tissue, a facial tissue, and an absorbent towel.

### DETAILED DESCRIPTION OF THE PREFERRED EMBODIMENTS

A sustainable, fibrous structure has now been found that is composed of filaments that are derived from renewable resources. The fibrous structures described herein are co-forms that include a plurality of filaments that have a biobased content of at least about 25% and/or at least about 35% and/or at least about 45% and/or at least about 50% and/or at least about 70% and/or at least about 75% and/or at least about 85% and/or at least about 90% and/or at least about 95%, for example, about 97%, about 99%, or about 100%, and are selected from the group consisting of polypropylene, polyethylene, polymethylpentene, polybutene-1, polyisobutylene, ethylene propylene copolymer, ethylene propylene diene monomer copolymer or rubber, and mixtures thereof; and, a plurality of solid additives selected from the group consisting of a cellulosic fiber, a granular substance, a powder, and mixtures thereof, wherein at least one solid additive comprises a cellulosic fiber.

As used herein, “sustainable” refers to a material having an improvement of greater than 10% in some aspect of its Life Cycle Assessment or Life Cycle Inventory, when compared to the relevant virgin, petroleum-based material that would otherwise have been used for manufacture. As used herein, “Life Cycle Assessment” (LCA) or “Life Cycle Inventory” (LCI) refers to the investigation and evaluation of the environmental impacts of a given product or service caused or necessitated by its existence. The LCA or LCI can involve a “cradle-to-grave” analysis, which refers to the full Life Cycle Assessment or Life Cycle Inventory from manufacture (“cradle”) to use phase and disposal phase (“grave”). For example, high density polyethylene (HDPE) containers can be recycled into HDPE resin pellets, and then used to form containers, films, or injection molded articles, for example, saving a significant amount of fossil-fuel energy. At the end of its life, the polyethylene can be disposed of by incineration, for example. All inputs and outputs are considered for all the phases of the life cycle. As used herein, “End of Life” (EoL) scenario refers to the disposal phase of the LCA or LCI. For example, polyethylene can be recycled, incinerated for energy (e.g., 1 kilogram of polyethylene produces as much energy as 1 kilogram of diesel oil), chemically transformed to other products, and recovered mechanically. Alternatively, LCA or LCI can involve a “cradle-to-gate” analysis, which refers to an assessment of a partial product life cycle from manufacture (“cradle”) to the factory gate (i.e., before it is transported to the customer) as a pellet. Alternatively, this second type of analysis is also termed “cradle-to-cradle.”

As used herein, the prefix “bio-” is used to designate a material that has been derived from a renewable resource. As used herein, a “renewable resource” is one that is produced by a natural process at a rate comparable to its rate of consumption (e.g., within a 100 year time frame). The resource can be replenished naturally, or via agricultural techniques. Non-limiting examples of renewable resources include plants (e.g., sugar cane, beets, corn, potatoes, citrus fruit, woody plants, lignocellulosics, hemicellulosics, cellulosic waste), animals, fish, bacteria, fungi, and forestry products. These resources can be naturally occurring, hybrids, or genetically engineered organisms. Natural resources such as crude oil, coal, natural gas, and peat, which take longer than 100 years to form, are not considered renewable resources. Because at least part of the fibrous structure of the invention is derived from a renewable resource, which can sequester carbon dioxide, use of the fibrous structure can reduce global warming potential and fossil fuel consumption. For example, some LCA or LCI studies on HDPE resin have shown that about one ton of polyethylene made from virgin, petroleum-based sources results in the emission of up to about 2.5 tons of carbon dioxide to the environment. Because sugar cane, for example, takes up carbon dioxide during growth, one ton of polyethylene made from sugar cane removes up to about 2.5 tons of carbon dioxide from the environment. Thus, use of about one ton of polyethylene from a renewable resource, such as sugar cane, results in a decrease of up to about 5 tons of environmental carbon dioxide versus using one ton of polyethylene derived from petroleum-based resources.

The renewable fibrous structures described herein are advantageous because they have the same performance characteristics as fibrous structures that include petroleum-derived filaments, yet they encompass improved sustainability, which reduces dependence on petroleum supplies.

As used herein, “basis weight” refers to the weight per unit area of a sample reported in lbs/3000 ft² or g/m².

As used herein, “machine direction” or “MD” refers to the direction parallel to the flow of the fibrous structure through the fibrous structure making machine and/or article (e.g., absorbent pad, paper or fabric) manufacturing equipment.

As used herein, “cross machine direction” or “CD” refers to the direction parallel to the width of the fibrous structure making machine and/or article (e.g., absorbent pad, paper or fabric) manufacturing equipment and perpendicular to the machine direction.

As used herein “ply” refers to an individual, integral fibrous structure.

As used herein, “plies” refers to two or more individual, integral fibrous structures disposed in a substantially contiguous, face-to-face relationship with one another, forming a multi-ply fibrous structure. It is also contemplated that an individual, integral fibrous structure can effectively form a multi-ply fibrous structure, for example, by being folded on itself.

As used herein, “total pore volume” refers to the sum of the fluid holding void volume in each pore range from 1 μm to 1000 m radii, as measured according to the Pore Volume Test Method described herein.

As used herein, “Pore Volume Distribution” refers to the distribution of fluid holding void volume as a function of pore radius. The Pore Volume Distribution of a fibrous structure is measured according to the Pore Volume Test Method described herein.

As used herein, “Liquid Absorptive Capacity” refers to a mass of liquid that is absorbed by unit mass of the test absorbent expressed as a percentage of the mass of the test absorbent, under specified conditions and after a specified time.

The articles “a” and “an” when used herein, for example, “an odor absorbing agent” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### Fibrous Structure

The co-formed fibrous structures of the invention include:

(a) plurality of filaments that have a biobased content of at least about 25% and/or at least about 35% and/or at least about 45% and/or at least about 50% and/or at least about 70% and/or at least about 75% and/or at least about 85% and/or at least about 90% and/or at least about 95%, for example, about 97%, about 99%, or about 100%, and are selected from the group consisting of polypropylene, polyethylene, polymethylpentene, polybutene-1, polyisobutylene, ethylene propylene copolymer, ethylene propylene diene monomer copolymer or rubber, and mixtures thereof; and,

(b) a solid additive comprising a cellulose fiber.

The solid additive can further include a compound selected from the group consisting of a granular substance, a powder, and mixtures thereof.

The fibrous structures can include any suitable amount of filament and any suitable amount of solid additive. For example, the fibrous structures can comprise filaments in an amount of about 10 wt. % to about 70 wt. %, about 20 wt. % to about 60 wt. %, or about 30 wt. % to about 50 wt. % by dry weight of the fibrous structure; and solid additives in an amount of about 90 wt. % to about 30 wt. %, about 80 wt. % to about 40 wt. %, or about 70 wt. % to about 50 wt. % by dry weight of the fibrous structure. The filaments and solid additives are in a weight ratio of at least about 1:1, at least about 1:1.5, at least about 1:2, at least about 1:2.5, at least about 1:3, at least about 1:4, at least about 1:5, at least about 1:7, or at least about 1:10 of filament to solid additive. In some preferred embodiments, the filament is polypropylene.

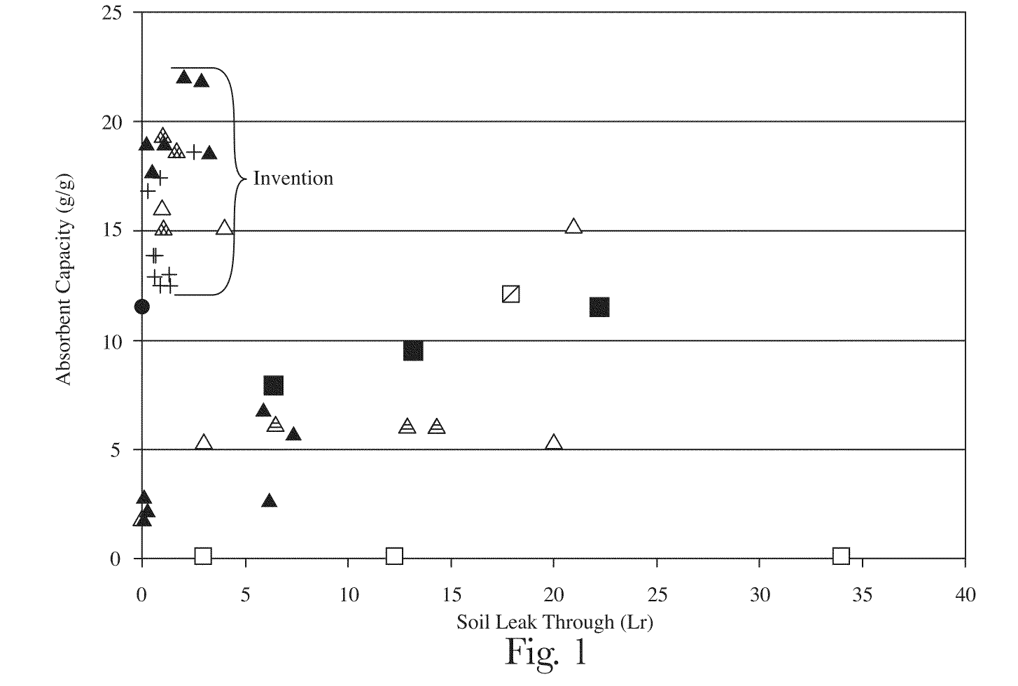

The plurality of filaments and plurality of solid additives can be dispersed randomly throughout the fibrous structure or in a pattern. Examples of different representations of fibrous structures can be found in FIGS. 1-7 of PCT application No. 2009/010938, incorporated herein by reference.

The fibrous structures of the present invention can be homogeneous (e.g., single ply) or can be layered (e.g., multi-ply, have plies). If layered, the fibrous structures can comprise at least two and/or at least three and/or at least four and/or at least five layers.

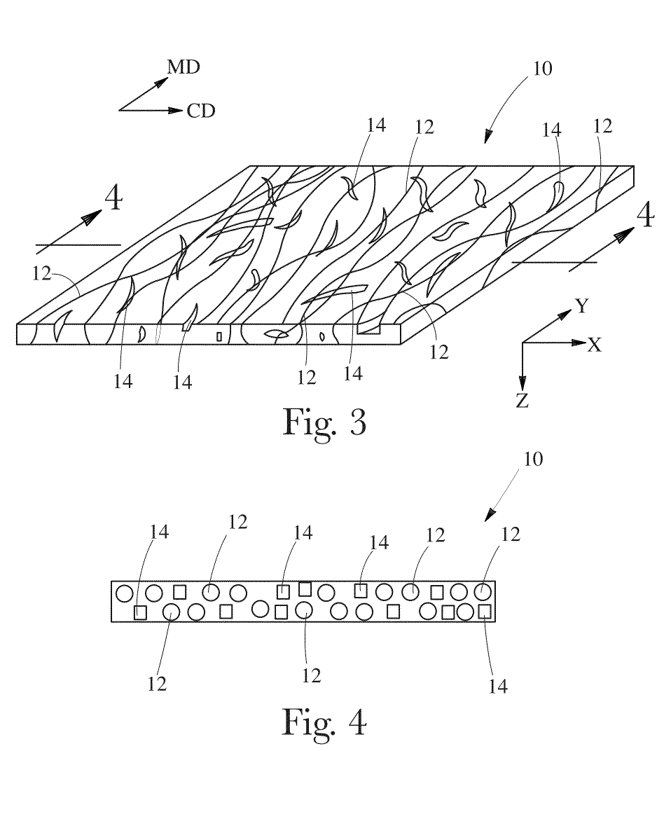

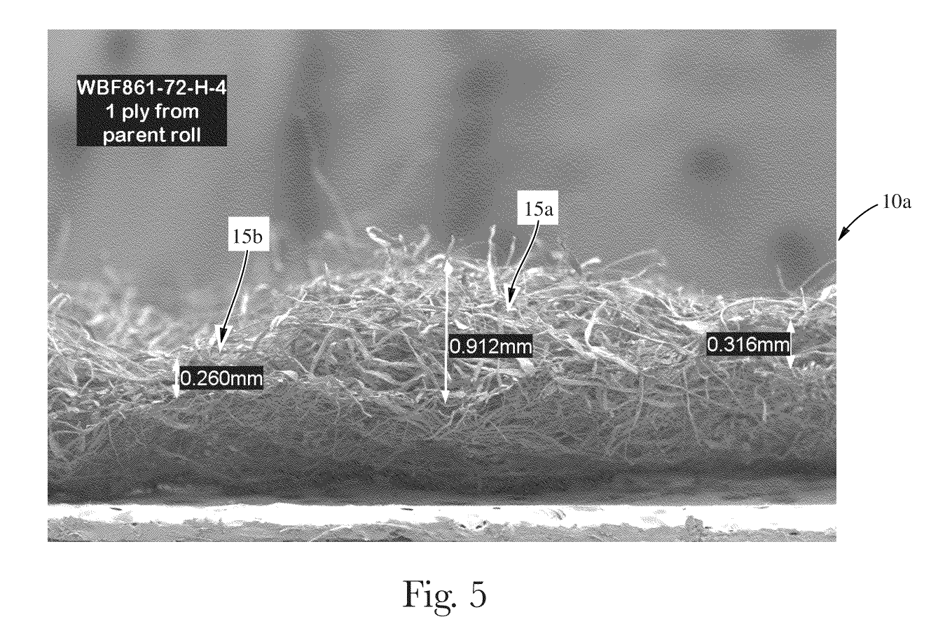

FIGS. 3 and 4 show schematic representations of an example of a fibrous structure described herein. As shown in FIGS. 3 and 4, the fibrous structure 10 may be a co-formed fibrous structure. The fibrous structure 10 comprises a plurality of filaments 12, such as bio-polypropylene filaments, and a plurality of solid additives, such as wood pulp fibers 14. The filaments 12 may be randomly arranged as a result of the process by which they are spun and/or formed into the fibrous structure 10. The wood pulp fibers 14, may be randomly dispersed throughout the fibrous structure 10 in the x-y plane. The wood pulp fibers 14 may be non-randomly dispersed throughout the fibrous structure in the z-direction. In one example (not shown), the wood pulp fibers 14 are present at a higher concentration on one or more of the exterior, x-y plane surfaces than within the fibrous structure along the z-direction.

FIG. 5 shows a cross-sectional, SEM microphotograph of another example of a fibrous structure 10a described herein, which comprises a non-random, repeating pattern of microregions 15a and 15b. The microregion 15a (typically referred to as a “pillow”) exhibits a different value of a common intensive property than microregion 15b (typically referred to as a “knuckle”). In one example, the microregion 15b is a continuous or semi-continuous network and the microregion 15a are discrete regions within the continuous or semi-continuous network. The common intensive property may be caliper. In another example, the common intensive property may be density.

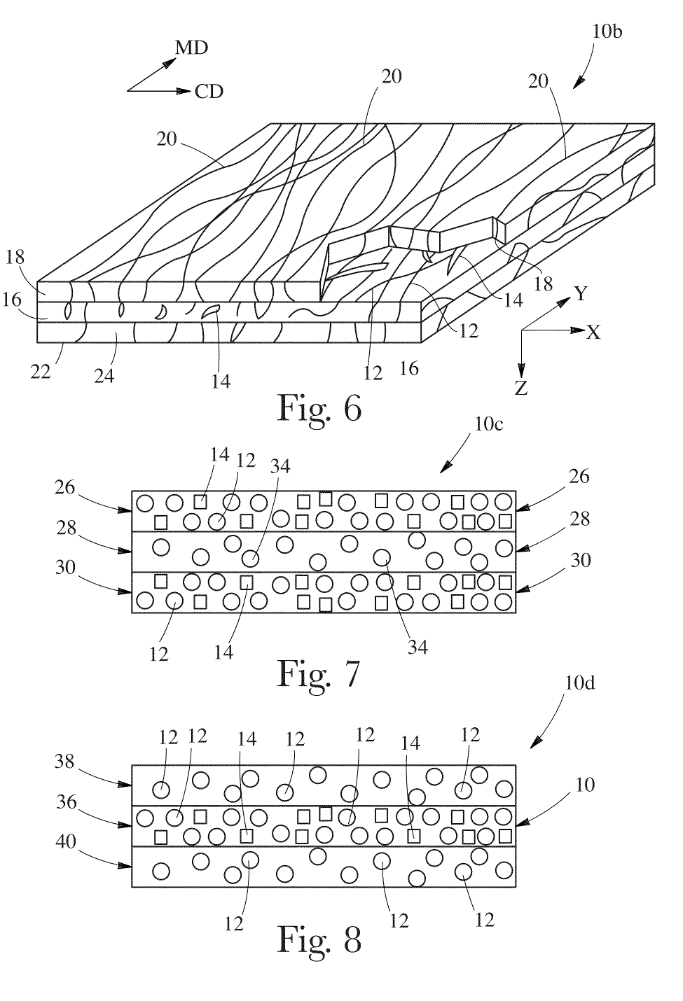

As shown in FIG. 6, another example of a fibrous structure in accordance with the present invention is a layered fibrous structure 10b. The layered fibrous structure 10b comprises a first layer 16 comprising a plurality of filaments 12, such as bio-polypropylene filaments, and a plurality of solid additives, in this example, wood pulp fibers 14. The layered fibrous structure 10b further comprises a second layer 18 comprising a plurality of filaments 20, such as bio-polypropylene filaments. In one example, the first and second layers 16, 18, respectively, are sharply defined zones of concentration of the filaments and/or solid additives. The plurality of filaments 20 may be deposited directly onto a surface of the first layer 16 to form a layered fibrous structure that comprises the first and second layers 16, 18, respectively.

Further, the layered fibrous structure 10b may comprise a third layer 22, as shown in FIG. 6. The third layer 22 may comprise a plurality of filaments 24, which may be the same or different from the filaments 20 and/or 16 in the second 18 and/or first 16 layers. As a result of the addition of the third layer 22, the first layer 16 is positioned, for example sandwiched, between the second layer 18 and the third layer 22. The plurality of filaments 24 may be deposited directly onto a surface of the first layer 16, opposite from the second layer, to form the layered fibrous structure 10b that comprises the first, second and third layers 16, 18, 22, respectively.

As shown in FIG. 7, a cross-sectional schematic representation of another example of a fibrous structure in accordance with the present invention comprising a layered fibrous structure 10c is provided. The layered fibrous structure 10c comprises a first layer 26, a second layer 28 and optionally a third layer 30. The first layer 26 comprises a plurality of filaments 12, such as bio-polypropylene filaments, and a plurality of solid additives, such as wood pulp fibers 14. The second layer 28 may comprise any suitable filaments, solid additives and/or polymeric films. In one example, the second layer 28 comprises a plurality of filaments 34.

In yet another example, a fibrous structure of the present invention may comprise two outer layers consisting of 100% by weight filaments and an inner layer consisting of 100% by weight fibers.

In another example of a fibrous structure in accordance with the present invention, instead of being layers of fibrous structure 10c, the material forming layers 26, 28 and 30, may be in the form of plies wherein two or more of the plies may be combined to form a fibrous structure. The plies may be bonded together, such as by thermal bonding and/or adhesive bonding, to form a multi-ply fibrous structure.

Another example of a fibrous structure of the present invention in accordance with the present invention is shown in FIG. 8. The fibrous structure 10d may comprise two or more plies, wherein one ply 36 comprises any suitable fibrous structure in accordance with the present invention, for example fibrous structure 10 as shown and described in FIGS. 3 and 4 and another ply 38 comprising any suitable fibrous structure, for example a fibrous structure comprising filaments 12, such as bio-polypropylene filaments. The fibrous structure of ply 38 may be in the form of a net and/or mesh and/or other structure that comprises pores that expose one or more portions of the fibrous structure 10d to an external environment and/or at least to liquids that may come into contact, at least initially, with the fibrous structure of ply 38. In addition to ply 38, the fibrous structure 10d may further comprise ply 40. Ply 40 may comprise a fibrous structure comprising filaments 12, such as bio-polypropylene filaments, and may be the same or different from the fibrous structure of ply 38.

Two or more of the plies 36, 38 and 40 may be bonded together, such as by thermal bonding and/or adhesive bonding, to form a multi-ply fibrous structure. After a bonding operation, especially a thermal bonding operation, it may be difficult to distinguish the plies of the fibrous structure 10d and the fibrous structure 10d may visually and/or physically be a similar to a layered fibrous structure in that one would have difficulty separating the once individual plies from each other. In one example, ply 36 may comprise a fibrous structure that exhibits a basis weight of at least about 15 g/m² and/or at least about 20 g/m² and/or at least about 25 g/m² and/or at least about 30 g/m² up to about 120 g/m² and/or 100 g/m² and/or 80 g/m² and/or 60 g/m² and the plies 38 and 42, when present, independently and individually, may comprise fibrous structures that exhibit basis weights of less than about 10 g/m² and/or less than about 7 g/m² and/or less than about 5 g/m² and/or less than about 3 g/m² and/or less than about 2 g/m² and/or to about 0 g/m² and/or 0.5 g/m².

Plies 38 and 40, when present, may help retain the solid additives, in this case the wood pulp fibers 14, on and/or within the fibrous structure of ply 36 thus reducing lint and/or dust (as compared to a single-ply fibrous structure comprising the fibrous structure of ply 36 without the plies 38 and 40) resulting from the wood pulp fibers 14 becoming free from the fibrous structure

### Renewable Filaments

The filaments may be monocomponent, multicomponent (e.g., bicomponent), or a mixture thereof. The filaments are at least partially derived from a renewable resource and have a biobased content of at least about 25% and/or at least about 35% and/or at least about 45% and/or at least about 50% and/or at least about 70% and/or at least about 75% and/or at least about 85% and/or at least about 90% and/or at least about 95%, for example, about 97%, about 99%, or about 100%. The renewable polymers used to form the filaments, for example, bio-polypropylene, bio-polyethylene, bio-polymethylpentene, bio-polybutene-1, bio-polyisobutylene, bio-ethylene propylene copolymer, bio-ethylene propylene diene monomer copolymer or rubber, and mixtures thereof, are formed from monomers derived from renewable resources. These monomers include bio-propylene, bio-ethylene, bio-4-methyl-1-pentene, bio-1-butylene, bio-isobutylene, bio-ethylene and bio-propylene, and bio-ethylene, bio-propylene, and a diene (e.g., bio-dicyclopentadiene, bio-ethylidene norbornene, and bio-vinyl norbornene), respectively.

### Bio-Alcohol Production

Monofunctional alcohols, such as methanol; ethanol; isomers of propanol, butanol, pentanol, and hexanol; cyclopentanol; isobornyl alcohol; and higher alcohols; and polyfunctional alcohols, such as ethylene glycol, isomers of propanediol, and glycerol, can be derived from renewable resources via a number of suitable routes (see, e.g., WO 2009/155086 and U.S. Pat. No. 4,536,584, each incorporated herein by reference).

In one route, a renewable resource, such as corn starch, can be enzymatically hydrolyzed to yield glucose and/or other sugars. The resultant sugars can be converted into alcohols by fermentation.

In another route, monofunctional alcohols, such as ethanol and propanol are produced from short chain acids, fatty acids, fats (e.g., animal fat), and oils (e.g., monoglycerides, diglycerides, triglycerides, and mixtures thereof). These short chain acids, fatty acids, fats, and oils can be derived from renewable resources, such as animals or plants. “Short chain acid” refers to a straight chain monocarboyxlic acid having a chain length of 3 to 5 carbon atoms. “Fatty acid” refers to a straight chain monocarboxylic acid having a chain length of 6 to 30 carbon atoms. “Monoglycerides,” “diglycerides,” and “triglycerides” refer to multiple mono-, di- and tri-esters, respectively, of (i) glycerol and (ii) the same or mixed short chain acids and/or fatty acids.

Non-limiting examples of short chain acids include propionic acid, butyric acid, and valeric acid. Non-limiting examples of saturated fatty acids include caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacoxylic acid, melissic acid, henatriacontylic acid, lacceroic acid, psyllic acid, geddic acid, ceroplastic acid, and henatriacontylic acid. Non-limiting examples of unsaturated fatty acids include oleic acid, myristoleic acid, palmitoleic acid, sapienic acid, linoleic acid, linolenic acid, arachidonic acid, eicosapentaenoic acid, and docosahexaenoic acid. Non-limiting examples of monoglycerides include monoglycerides of any of the fatty acids described herein. Non-limiting examples of diglycerides include diglycerides of any of the fatty acids described herein. Non-limiting examples of the triglycerides include triglycerides of any of the fatty acids described herein, such as, for example, tall oil, corn oil, soybean oil, sunflower oil, safflower oil, linseed oil, perilla oil, cotton seed oil, tung oil, peanut oil, oiticica oil, hempseed oil, marine oil (e.g. alkali-refined fish oil), dehydrated castor oil, and mixtures thereof. Alcohols can be produced from fatty acids through reduction of the fatty acids by any method known in the art. Alcohols can be produced from fats and oils by first hydrolyzing the fats and oils to produce glycerol and fatty acids, and then subsequently reducing the fatty acids.

In another route, genetically engineered cells and microorganisms are provided that produce products from the fatty acid biosynthetic pathway (i.e., fatty acid derivatives), such as fatty alcohols, as described in International Patent Application Publication No. WO 2008/119082, incorporated herein by reference. For example, a gene encoding a fatty alcohol biosynthetic polypeptide that can be used to produce fatty alcohols, or a fatty aldehyde biosynthetic polypeptide that can be used to produce fatty aldehydes, which subsequently can be converted to fatty alcohols, is expressed in a host cell. The resulting fatty alcohol or fatty aldehyde then is isolated from the host cell. Such methods are described in U.S. Patent Application Publication Nos. 2010/0105963 and 2010/0105955, and International Patent Application Publication Nos. WO 2010/062480 and WO 2010/042664, each incorporated herein by reference.

In another route, fatty acyl chains are produced from renewable biocrude or hydrocarbon feedstocks using recombinant microorganisms, wherein at least one hydrocarbon is produced by the recombinant microorganism. The fatty acyl chains subsequently can be converted to fatty alcohols using methods known in the art. The microorganisms can be engineered to produce specific degrees of branching, saturation, and length, as described in U.S. Patent Application Publication No. 2010/017826, incorporated herein by reference.

### Steam Cracking

Bio-ethylene, bio-propylene, bio-butadiene, bio-isoprene, bio-cyclopentadiene, bio-piperylene, bio-benzene, bio-toluene, bio-xylene, and bio-gasoline can be produced from a steamcracking procedure, as described in PCT Publication No. 2011/012438, which is incorporated herein by reference. In this method, a feedstock containing a complex mixture of naturally occurring oils and fats and/or triglycerides is mixed with steam in a steam/feedstock ratio of at least 0.2 kg per kg, a coil outlet temperature of at least 700° C., and a coil outlet pressure of at least 1.2 bara in order to obtain the aforementioned cracking products.

### Bio-Ethylene Production

Bio-ethylene can be formed from the dehydration of bio-ethanol. Bio-ethanol can be derived from, for example, (i) the fermentation of sugar from sugar cane, sugar beet, or sorghum; (ii) the saccharification of starch from maize, wheat, or manioc; and (iii) the hydrolysis of cellulosic materials. U.S. Patent Application Publication No. 2005/0272134, incorporated herein by reference, describes the fermentation of sugars to form alcohols and acids.

As previously described, suitable sugars used to form ethanol include monosaccharides, disaccharides, trisaccharides, and oligosaccharides. Sugars, such as sucrose, glucose, fructose, and maltose, are readily produced from renewable resources, such as sugar cane and sugar beets.

Sugars also can be derived (e.g., via enzymatic cleavage) from other agricultural products (i.e., renewable resources resulting from the cultivation of land or the husbandry of animals). For example, glucose can be prepared on a commercial scale by enzymatic hydrolysis of corn starch. Other common agricultural crops that can be used as the base starch for conversion into glucose include wheat, buckwheat, arracaha, potato, barley, kudzu, cassava, sorghum, sweet potato, yam, arrowroot, sago, and other like starchy fruit, seeds, or tubers. The sugars produced by these renewable resources (e.g., corn starch from corn) can be used to produce ethanol, as well as other alcohols, such as propanol, and methanol. For example, corn starch can be enzymatically hydrolyzed to yield glucose and/or other sugars. The resultant sugars can be converted into ethanol by fermentation.

In one embodiment, bio-ethylene is produced from sugar cane. The life cycle stages of ethylene production from sugar cane include (i) sugar cane farming, (ii) fermentation of sugar cane to form bio-ethanol, and (iii) dehydration of bio-ethanol to form ethylene. Specifically, sugar cane is washed and transported to mills where sugar cane juice is extracted, leaving filter cake, which is used as fertilizer, and bagasse (residual woody fiber of the cane obtained after crushing). The bagasse is burned to generate steam and the electricity used to power the sugar cane mills, thereby reducing the use of petroleum-derived fuels. The sugar cane juice is fermented using yeast to form a solution of ethanol and water. The ethanol is distilled from the water to yield about 95% pure bio-ethanol. The bio-ethanol is subjected to catalytic dehydration (e.g., with an alumina catalyst) to produce bio-ethylene.

Advantageously, a Life Cycle Assessment and Inventory of ethylene produced from sugar cane shows favorable benefits in some aspects over ethylene produced from petroleum feedstock for global warming potential, abiotic depletion, and fossil fuel consumption. For example, some studies have shown that about one ton of polyethylene made from virgin petroleum-based sources results in the emission of up to about 2.5 tons of carbon dioxide to the environment, as previously described. Thus, use of up to about one ton of polyethylene from a renewable resource, such as sugar cane, results in a decrease of about 5 tons of environmental carbon dioxide versus using one ton of polyethylene derived from petroleum-based resources.

### Bio-Propylene

Bio-propylene can be formed from the dehydration of bio-propanol. Renewable resources used to derive bio-propanol are as previously described. Bio-propanol also can be derived from bio-ethylene. In this pathway, bio-ethylene is converted into bio-propionaldehyde by hydroformylation using carbon monoxide and hydrogen in the presence of a catalyst, such as cobalt octacarbonyl or a rhodium complex. Hydrogenation of the bio-propionaldehyde in the presence of a catalyst, such as sodium borohydride and lithium aluminum hydride, yields bio-propan-1-ol, which can be dehydrated in an acid catalyzed reaction to yield bio-propylene, as described in U.S. Patent Application Publication No. 2007/0219521, incorporated herein by reference.

### Bio-4-Methyl-1-Pentene

Bio-4-methyl-1-pentene can be formed from the catalytic dimerization of bio-propylene using methods known to one skilled in the art, such as the methods described in Shaw et al., J. of Organic Chem. 39(10):3286-3289 (1965); Forni and Invernizzi Ind. Eng. Chem. Process Des. Dev., 12(4):455-459, 1973; Chauvin et al., Ind. Eng. Chem. Res. 34(4):1149-1155 (1995); Yankov et al., Chemical Engineering & Technology 17(5):354-357 (1994); and Lang et al., Journal of Molecular Catalysis A: Chemical 322(1-2):45-49 (2010), each incorporated herein by reference.

### Bio-1-Butylene

Bio-1-butylene can be formed from the dehydration of bio-butanol. Renewable resources used to derive bio-butanol are as previously described. Bio-butanol also can be derived by the fermentation of biomass using the acetone-butanol-ethanol (ABE) fermentation process with Clostridium acetobuylicum, or with solar energy from algae. Other methods to produce bio-butanol include hydrogenation of bio-n-butyraldehyde, the Shell hydroformylation of bio-propylene and synthesis gas, and hydrogenation of bio-crotonaldehyde. Bio-1-butylene also can be formed from the dimerization of bio-ethylene.

### Bio-Isobutylene

Bio-isobutylene can be formed from the dehydration of bio-isobutanol. Bio-isobutanol can be produced by the carbonylation of bio-propylene. Isobutanol is produced naturally during the fermentation of carbohydrates, and also can be produced by some engineered microorganisms, such as corynebacterium. The US Department of Energy's BioEnergy Science Center at Oak Ridge National Laboratory has demonstrated the production of bio-isobutanol using the process of consolidated bioprocessing where Clostridium celluloycium bacteria directly convert cellulose to isobutanol.

### Bio-Dicyclopentadiene

Bio-dicyclopentadiene can be produced from the dimerization of bio-cyclopentadiene using methods known to one skilled in the art. Bio-cyclopentadiene can be produced using a steam cracking process, as previously described.

### Bio-Vinyl Norbornene

Bio-vinyl norbornene can be produced from bio-cyclopentadiene and bio-butadiene in a Diels-Alder reaction. Bio-cyclopentadiene and bio-butadiene can be produced using a steam cracking process, as previously described. Other methods for producing bio-butadiene include the single-step Lebedev process using bio-ethanol, and the two-step Ostromislensky process using bio-ethanol and bio-acetaldehyde (obtained from the oxidation of bio-ethanol) over a tantalum-promoted porous silica catalyst at 325-350° C.

### Bio-Ethylidene Norbornene

Bio-ethylidene norbornene can be produced by isomerizing bio-vinyl norbornene using a base.

### Additives

The renewable filaments and/or compositions used to produce the renewable filaments may comprise one or more additives, such as an oil and/or a wetting agent.

### Oils

An oil, as used herein, means a lipid, mineral oil, and/or mixtures thereof, having a melting point of 25° C. or less and a boiling point of greater than 160° C. Non-limiting examples of suitable lipids include monoglycerides, diglycerides, triglycerides, fatty acids, fatty alcohols, esterified fatty acids, epoxidized lipids, maleated lipids, hydrogenated lipids, alkyd resins derived from a lipid, sucrose polyesters, and mixtures thereof. Non-limiting examples of suitable triglyerides include triolein, trilinolein, 1-stearodilinolein, 1,2-diacctopalmitin, and mixtures thereof.

Non-limiting examples of suitable oils include castor oil, coconut oil, coconut seed oil, corn germ oil, cottonseed oil, linseed oil, fish oil, olive oil, oiticica oil, palm kernel oil, palm oil, palm seed oil, peanut oil, hempseed oil, rapeseed oil, safflower oil, soybean oil, canola oil, sperm oil, sunflower seed oil, tall oil, tung oil, whale oil, and mixtures thereof. In one example, the oil is selected from the group consisting of: corn oil, soybean oil, canola oil, cottonseed oil, palm kernel oil, and mixtures thereof. The oils can be pure and/or processed and/or recycled oils, such as those used at least once, for example in cooking. The oils can be from edible plant sources and/or inedible plant sources. Edible plant sources include soybeans and/or corn. Oils from inedible plant sources include jatropha oil and some variants of rapeseed oils.

Other oils that may be used include 1-palmito-dilinolein, lauroleic acid, linoleic acid, linolenic acid, myristoleic acid, oleic acid, palmitoleic acid, and combinations thereof.

The oil can be from a renewable material (e.g., derived from a renewable resource). As used herein, a “renewable resource” is one that is produced by a natural process at a rate comparable to its rate of consumption (e.g., within a 100 year time frame). The resource can be replenished naturally, or via agricultural techniques. Non-limiting examples of renewable resources include plants (e.g., sugar cane, beets, corn, potatoes, citrus fruit, woody plants, lignocellulosics, hemicellulosics, cellulosic waste), animals, fish, bacteria, fungi, and forestry products. These resources can be naturally occurring, hybrids, or genetically engineered organisms. Natural resources such as crude oil, coal, natural gas, and peat, which take longer than 100 years to form are not considered renewable resources. Mineral oil is viewed as a by-product waste stream of coal, and while not renewable, it can be considered a by-product oil.

The oil, as disclosed herein, may be present in the renewable filament and/or composition at a weight percent of about 5 wt % to about 40 wt %, based upon the total weight of the renewable filament and/or composition. Other contemplated wt % ranges of the oil include about 8 wt % to about 30 wt %, for example from about 10 wt % to about 30 wt %, about 10 wt % to about 20 wt %, or about 12 wt % to about 18 wt %, based upon the total weight of the renewable filament and/or composition. Specific oil wt % contemplated include about 5 wt %, about 6 wt %, about 7 wt %, about 8 wt %, bout 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, abut 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, and about 40 wt %, based upon the total weight of the renewable filament and/or composition.

### Cellulosic Fiber

The cellulosic fiber component of the fibrous structures described herein can be a papermaking fiber. Non-limiting examples of papermaking fibers include those derived from a mechanical pulp, a thermomechanical pulp, a chemithermomechanical pulp, a chemical pulp a recycled pulp, bagasse, grass, grain, or mixtures thereof. In some embodiments, the cellulosic fiber is selected from the group consisting of a softwood pulp fiber (i.e., derived from a coniferous tree), a hardwood pulp fiber (i.e., derived from a deciduous tree), a groundwood pulp fiber, a cotton linter fiber, a sulfite pulp fiber, a sulfate pulp fiber, a rayon fiber, a lyocell fiber, and mixtures thereof. In some embodiments, the cellulosic fiber is selected from the group consisting of a Southern Softwood Kraft pulp fiber, a Northern Softwood Kraft pulp fiber, a Eucalyptus pulp fiber, an Acacia pulp fiber, and mixtures thereof. Any of the cellulosic fibers can be blended together. Alternatively, different types of cellulosic fibers can be deposited in layers to provide a stratified web. For example, U.S. Pat. Nos. 4,300,981 and 3,994,771, each incorporated herein by reference, disclose the layering of hardwood and softwood fibers in a fibrous structure. The recycled pulp of the invention can include any of the above categories of pulp, as well as other non-fibrous materials, such as fillers and adhesives used to facilitate the original papermaking.

### Pore Volume Distribution

Consumers of fibrous structures, especially paper towels, often prefer absorbency properties, such as absorption capacity and/or rate of absorption, in their fibrous structures. The pore volume distribution present in the fibrous structures impacts the absorbency properties of the fibrous structures. Some fibrous structures exhibit pore volume distributions that optimize the absorption capacity, while others exhibit pore volume distributions that optimize the rate of absorption. PCT Application No. 2009/010938 (“the '938 application”), incorporated herein by reference, discloses fibrous structures that balance the properties of absorption capacity with rate of absorption via the pore volume distribution exhibited by the fibrous structures.

In some embodiments, the fibrous structures described herein exhibit a balanced a pore volume distribution, as described in the '938 application, such that greater than about 40%, and/or greater than about 45%, and/or greater than about 50%, and/or greater than about 55%, and/or greater than about 60%, and/or greater than about 75%, of the total pore volume present in the fibrous structures exists in pores of radii of about 121 μm to about 200 μm, and/or about 121 μm to about 180 μm, and/or about 121 μm to about 160 μm, as determined by the Pore Volume Distribution Test Method described herein.

In some embodiments, the fibrous structures described herein exhibit a pore volume distribution such that greater than about 50%, and/or greater than about 55%, and/or greater than about 60%, and/or greater than about 75% of the total pore volume present in the fibrous structures exists in pores of radii of about 101 μm to about 200 μm, and/or about 101 μm to about 180 μm, and/or about 101 μm to about 160 μm, as determined by the Pore Volume Distribution Test Method described herein.

In some embodiments, the fibrous structures described herein exhibit a pore volume distribution such that greater than about 40%, and/or greater than about 45%, and/or greater than about 50%, and/or greater than about 55%, and/or greater than about 60%, and/or greater than about 75% of the total pore volume present in the fibrous structures exists in pores of radii of about 121 μm to about 200 μm, as determined by the Pore Volume Distribution Test Method described herein, and exhibit a pore volume distribution such that greater than about 50%, and/or greater than about 55%, and/or greater than about 60%, and/or greater than about 75%, of the total pore volume present in the fibrous structures exists in pores of radii of about 101 μm to about 200 μm, as determined by the Pore Volume Distribution Test Method described herein. Such fibrous structures exhibit consumer-recognizable beneficial absorbent capacity.

In some embodiments, the fibrous structures described herein exhibit a bimodal pore volume distribution such that the greater than about 40%, and/or greater than about 45%, and/or greater than about 50%, and/or greater than about 55%, and/or greater than about 60%, and/or greater than about 75% of the total pore volume present in the fibrous structures exists in pores of radii of about 121 μm to about 200 μm, as determined by the Pore Volume Distribution Test Method described herein, and greater than about 2%, and/or greater than about 5%, and/or greater than about 10%, of the total pore volume present in the fibrous structures exists in pores of radii of less than about 100 μm, and/or less than about 80 μm, and/or less than about 50 μm, and/or about 1 μm to about 100 μm, and/or about 5 μm to about 75 μm, and/or about 10 μm to about 50 μm. A fibrous structure that exhibits a bimodal pore volume distribution provides beneficial absorbent capacity and absorbent rate as a result of the larger radii pores and beneficial surface drying as a result of the small radii pores.

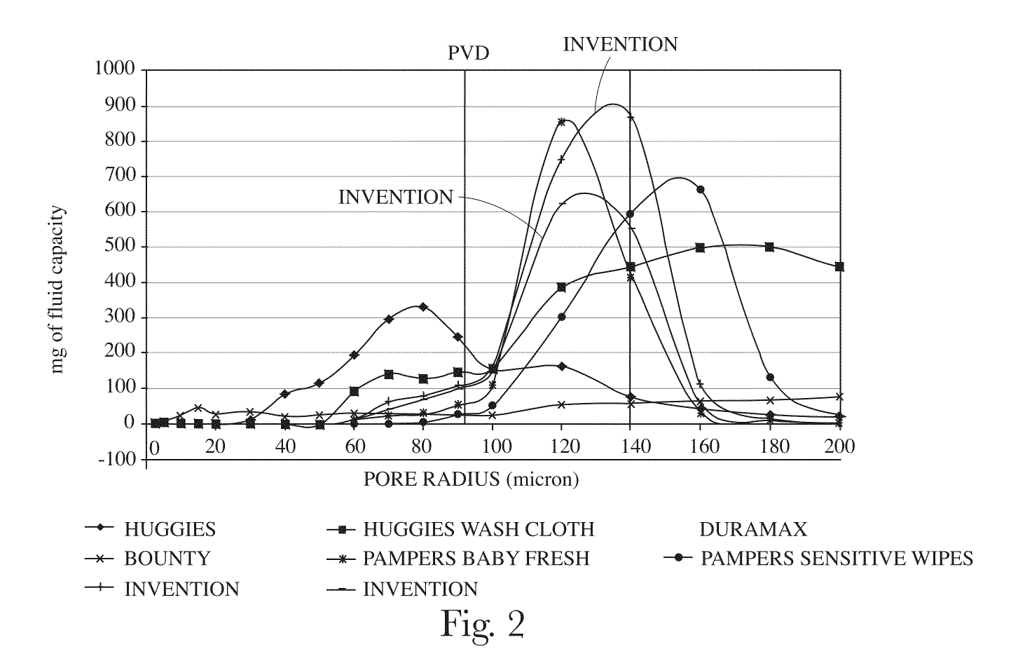

FIG. 2 shows that the fibrous structures with pore volume distributions described herein.

### Liquid Absorptive Capacity

The fibrous structures of the present invention exhibit a Liquid Absorptive Capacity higher than other known structured and/or textured fibrous structures as measured according to the Liquid Absorptive Capacity Test Method described herein. The fibrous structures of the present invention may exhibit a Liquid Absorptive Capacity of at least 2.5 g/g and/or at least 4.0 g/g and/or at least 7 g/g and/or at least 12 g/g and/or at least 13 g/g and/or at least 13.5 g/g and/or to about 30.0 g/g and/or to about 20 g/g and/or to about 15.0 g/g as measured according to the Liquid Absorptive Capacity Test Method described herein. FIG. 1 shows that the combination of Liquid Absorptive Capacity and Soil Leak Through of fibrous structures described herein.

### Method of Making the Fibrous Structures

Any method known to one skilled in the art for making fibrous structures can be employed to made the fibrous structures described herein. U.S. Patent Publication No. 2009/0218057 and PCT Application No. 2009/010938, each incorporated herein by reference, describe methods for making fibrous structures.

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt, such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

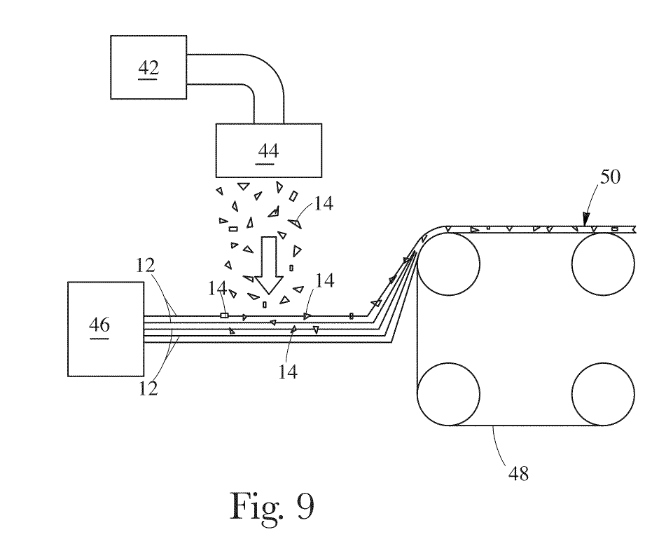

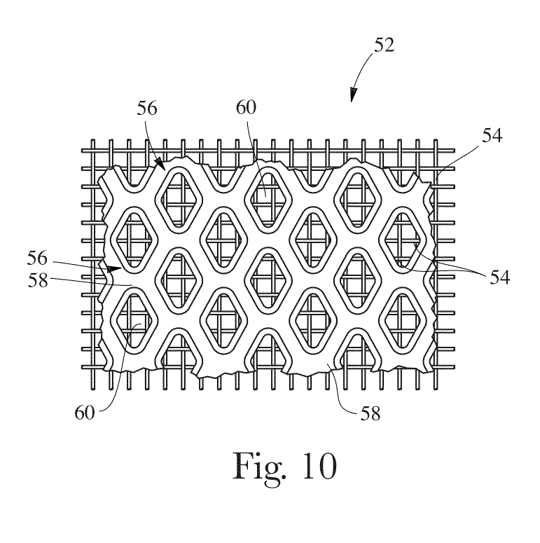

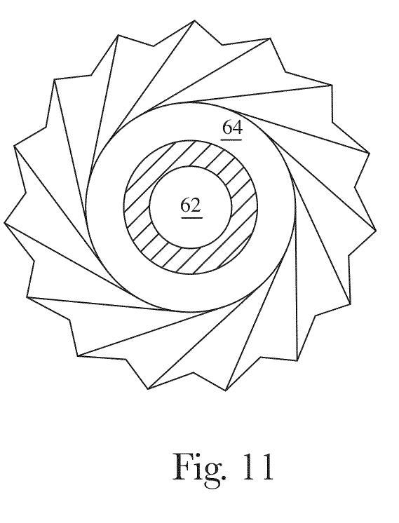

A non-limiting example of a method for making a fibrous structure described herein is represented in FIG. 9. The method shown in FIG. 9 comprises the step of mixing a plurality of solid additives 14 with a plurality of filaments 12. In one example, the solid additives 14 are wood pulp fibers, such as SSK fibers and/or Eucalyptus fibers, and the filaments 12 are bio-polypropylene filaments. The solid additives 14 may be combined with the filaments 12, such as by being delivered to a stream of filaments 12 from a hammermill 42 via a solid additive spreader 44 to form a mixture of filaments 12 and solid additives 14. The filaments 12 may be created by meltblowing from a meltblow die 46. The mixture of solid additives 14 and filaments 12 are collected on a collection device, such as a belt 48 to form a fibrous structure 50. The collection device may be a patterned and/or molded belt that results in the fibrous structure exhibiting a surface pattern, such as a non-random, repeating pattern of microregions. The molded belt may have a three-dimensional pattern on it that gets imparted to the fibrous structure 50 during the process. For example, the patterned belt 52, as shown in FIG. 10, may comprise a reinforcing structure, such as a fabric 54, upon which a polymer resin 56 is applied in a pattern. The pattern may comprise a continuous or semi-continuous network 58 of the polymer resin 56 within which one or more discrete conduits 60 are arranged.

In one example, the fibrous structures are made using a die comprising at least one filament-forming hole, and/or 2 or more, and/or 3 or more rows of filament-forming holes from which filaments are spun. At least one row of holes contains 2 or more, and/or 3 or more, and/or 10 or more filament-forming holes. In addition to the filament-forming holes, the die comprises fluid-releasing holes, such as gas-releasing holes, in one example air-releasing holes, that provide attenuation to the filaments formed from the filament-forming holes. One or more fluid-releasing holes may be associated with a filament-forming hole such that the fluid exiting the fluid-releasing hole is parallel or substantially parallel (rather than angled like a knife-edge die) to an exterior surface of a filament exiting the filament-forming hole. In one example, the fluid exiting the fluid-releasing hole contacts the exterior surface of a filament formed from a filament-forming hole at an angle of less than 30°, and/or less than 20°, and/or less than 10°, and/or less than 5°, and/or about 0°. One or more fluid releasing holes may be arranged around a filament-forming hole. In one example, one or more fluid-releasing holes are associated with a single filament-forming hole such that the fluid exiting the one or more fluid releasing holes contacts the exterior surface of a single filament formed from the single filament-forming hole. In one example, the fluid-releasing hole permits a fluid, such as a gas, for example air, to contact the exterior surface of a filament formed from a filament-forming hole rather than contacting an inner surface of a filament, such as what happens when a hollow filament is formed.

In one example, the die comprises a filament-forming hole positioned within a fluid-releasing hole. The fluid-releasing hole 62 may be concentrically or substantially concentrically positioned around a filament-forming hole 64, such as is shown in FIG. 11.

After the fibrous structure 50 has been formed on the collection device, such as a patterned belt or a woven fabric for example a through-air-drying fabric, the fibrous structure 50 may be calendered, for example, while the fibrous structure is still on the collection device. In addition, the fibrous structure 50 may be subjected to post-processing operations such as embossing, thermal bonding, tuft-generating operations, moisture-imparting operations, and surface treating operations to form a finished fibrous structure. One example of a surface treating operation that the fibrous structure may be subjected to is the surface application of an elastomeric binder, such as ethylene vinyl acetate (EVA), latexes, and other elastomeric binders. Such an elastomeric binder may aid in reducing the lint created from the fibrous structure during use by consumers. The elastomeric binder may be applied to one or more surfaces of the fibrous structure in a pattern, especially a non-random, repeating pattern of microregions, or in a manner that covers or substantially covers the entire surface(s) of the fibrous structure.

In one example, the fibrous structure 50 and/or the finished fibrous structure may be combined with one or more other fibrous structures. For example, another fibrous structure, such as a filament-containing fibrous structure, such as a bio-polypropylene filament fibrous structure may be associated with a surface of the fibrous structure 50 and/or the finished fibrous structure. The bio-polypropylene filament fibrous structure may be formed by meltblowing bio-polypropylene filaments (filaments that comprise a second polymer that may be the same or different from the polymer of the filaments in the fibrous structure 50) onto a surface of the fibrous structure 50 and/or finished fibrous structure. In another example, the bio-polypropylene filament fibrous structure may be formed by meltblowing filaments comprising a second polymer that may be the same or different from the polymer of the filaments in the fibrous structure 50 onto a collection device to form the bio-polypropylene filament fibrous structure. The bio-polypropylene filament fibrous structure may then be combined with the fibrous structure 50 or the finished fibrous structure to make a two-ply fibrous structure—three-ply if the fibrous structure 50 or the finished fibrous structure is positioned between two plies of the polypropylene filament fibrous structure like that shown in FIG. 6 for example. The bio-polypropylene filament fibrous structure may be thermally bonded to the fibrous structure 50 or the finished fibrous structure via a thermal bonding operation.

In yet another example, the fibrous structure 50 and/or finished fibrous structure may be combined with a filament-containing fibrous structure such that the filament-containing fibrous structure, such as a polysaccharide filament fibrous structure, such as a starch filament fibrous structure, is positioned between two fibrous structures 50 or two finished fibrous structures like that shown in FIG. 8 for example.

In one example of the present invention, the method for making a fibrous structure according to the present invention comprises the step of combining a plurality of filaments and optionally, a plurality of solid additives to form a fibrous structure that exhibits the properties of the fibrous structures of the present invention described herein. In one example, the filaments comprise thermoplastic filaments. In one example, the filaments comprise polypropylene filaments (e.g., bio-polypropylene filaments).

The method may further comprise subjecting the fibrous structure to one or more processing operations, such as calendaring the fibrous structure. In yet another example, the method further comprises the step of depositing the filaments onto a patterned belt that creates a non-random, repeating pattern of micro regions.

In still another example, two plies of fibrous structure 50 comprising a non-random, repeating pattern of microregions may be associated with one another such that protruding microregions, such as pillows, face inward into the two-ply fibrous structure formed.

The process for making fibrous structure 50 may be close coupled (where the fibrous structure is convolutedly wound into a roll prior to proceeding to a converting operation) or directly coupled (where the fibrous structure is not convolutedly wound into a roll prior to proceeding to a converting operation) with a converting operation to emboss, print, deform, surface treat, thermal bond, cut, stack or other post-forming operation known to those in the art. For purposes of the present invention, direct coupling means that the fibrous structure 50 can proceed directly into a converting operation rather than, for example, being convolutedly wound into a roll and then unwound to proceed through a converting operation.

In one example, the fibrous structure is embossed, cut into sheets, and collected in stacks of fibrous structures.

The process of the present invention may include preparing individual rolls and/or sheets and/or stacks of sheets of fibrous structure and/or sanitary tissue product comprising such fibrous structure(s) that are suitable for consumer use.

### Post-Processing

The fibrous structures described herein can be subjected to any post-processing operation, such as an embossing operation; a printing operation; a tuft-generating operation; a thermal bonding operation; an ultrasonic bonding operation; a perforating operation; a surface treatment operation, such as application of lotions, silicones, and/or other materials; and mixtures thereof.

In some embodiments, the fibrous structure is embossed. The embossed fibrous structure can be creped or uncreped. The embossed fibrous structure can exhibit a Geometric Mean Elongation of greater than about 14.95%, measured according to the Elongation Test Method, and as described in U.S. Publication No. 2009/0218057, incorporated herein by reference. The embossed fibrous structure also can exhibit a Dry Burst of greater than 360 g, as measured by the Dry Burst Test Method and/or a Geometric Mean Modulus of greater than about 1015 g/cm, as measured according to the Modulus Test Method, both of which are described in U.S. Publication No. 2009/0218057.

Any hydrophobic or non-hydrophilic materials within the fibrous structure, such as a polypropylene filament, can be surface treated and/or melt treated with a hydrophilic modifier. Non-limiting examples of hydrophilic modifiers that can be used to surface treat filaments include surfactants, such as Triton X-100. Non-limiting examples of hydrophilic modifiers that can be used to melt treat filaments include VW351, which is commercially available from Polyvel, Inc. and Irgasurf, which is commercially available from Ciba. In the process of melt treating, the hydrophilic modifier is added to a melt, such as a polypropylene melt, prior to spinning filaments. The hydrophilic modifier that is used to treat filaments can be associated with the hydrophobic or non-hydrophilic filament in any suitable amount known in the art. For example, the hydrophilic modifier can be associated with the hydrophobic or non-hydrophilic filament in an amount of up to about 20 wt. %, and/or up to about 15 wt. %, and/or up to about 10 wt. %, and/or up to about 5 wt. %, and/or up to about 3 wt. %, and/or 0 wt. %, based on the total filament weight.

The fibrous structures described herein can include one or more secondary additives, each, when present, at individual levels of about 0.01 wt. %, and/or about 0.1 wt. %, and/or about 1 wt. %, and/or about 2 wt. % to about 95 wt. %, and/or about 80 wt. % and/or about 50 wt. %, and/or about 30 wt. % and/or about 20 wt. %, based on the by dry weight of the fibrous structure. Non-limiting examples of secondary additives include a softening agent, a bulk softening agent, a lotion, a silicone, a latex, a surface-pattern-applied latex, a dry strength agent (e.g., carboxymethylcelluclose, and starch), a temporary wet strength agent, a permanent wet strength agent, a wetting agent, a lint reducing agent, an opacity increasing agent, an odor absorbing agent, a perfume, a temperature indicating agent, a color agent, a dye, an osmotic material, a microbial growth detection agent, an antibacterial agent.

### Fibrous Structure Embodiments

In some embodiments, the fibrous structure itself can be an absorbent pad (e.g., a sanitary tissue, a sanitary napkin, a diaper, and a wipe), a paper, and a fabric.

The fibrous structures described herein (e.g., wipes) may be saturation loaded with a liquid composition to form a pre-moistened fibrous structure. The loading may occur individually, or after the fibrous structures are placed in a stack, such as within a liquid impervious container or packet. In one example, pre-moistened wipes may be saturation loaded with about 1.5 g to about 6.0 g, and/or about 2.5 g to about 4.0 g of liquid composition per g of wipe.

The fibrous structures described herein (e.g., wipes) may be placed in the interior of a container, which may be liquid impervious, such as a plastic tub or a sealable packet, for storage and eventual sale to the consumer. The fibrous structures (e.g., wipes) may be folded and stacked. The fibrous structures (e.g., wipes) can be folded in any of various known folding patterns, such as C-folding, Z-folding and quarter-folding. Use of a Z-fold pattern can enable a folded stack of fibrous structures (e.g., wipes) to be interleaved with overlapping portions. Alternatively, the fibrous structures (e.g., wipes) may include a continuous strip of material which has perforations between each fibrous structure and which may be arranged in a stack or wound into a roll for dispensing, one after the other, from a container, which may be liquid impervious.

The fibrous structures described herein can further comprise prints, which may provide aesthetic appeal. Non-limiting examples of prints include figures, patterns, letters, pictures and combinations thereof.

### Sanitary Tissue

The fibrous structure of the present invention may itself be a sanitary tissue product. It may be convolutedly wound about a core to form a roll. It may be combined with one or more other fibrous structures as a ply to form a multi-ply sanitary tissue product. In one example, a co-formed fibrous structure of the present invention may be convolutedly wound about a core to form a roll of co-formed sanitary tissue product. The rolls of sanitary tissue products may also be coreless.

The sanitary tissue described herein is a soft, low density (e.g. less than about 0.15 g/cm³) web that is useful as a wiping implement for post-urinary and post-bowel movement cleaning (e.g., a toilet tissue), for otorhinolaryngological discharges (e.g., a facial tissue), and multi-functional absorbent and cleaning uses (e.g., an absorbent towel). The sanitary tissue product may be convolutedly wound upon itself about a core or without a core to form a sanitary tissue product roll.

The sanitary tissue described herein can exhibit a total dry tensile strength of greater than about 59 g/cm (150 g/in), and/or about 78 g/cm (200 g/in) to about 394 g/cm (1000 g/in), and/or about 98 g/cm (250 g/in) to about 335 g/cm (850 g/in). In addition, the sanitary tissue described herein can exhibit a total dry tensile strength of greater than about 196 g/cm (500 g/in), and/or about 196 g/cm (500 g/in) to about 394 g/cm (1000 g/in), and/or about 216 g/cm (550 g/in) to about 335 g/cm (850 g/in), and/or about 236 g/cm (600 g/in) to about 315 g/cm (800 g/in). For example, the sanitary tissue can exhibit a total dry tensile strength of less than about 394 g/cm (1000 g/in), and/or less than about 335 g/cm (850 g/in).

In another example, the sanitary tissue can exhibit a total dry tensile strength of greater than about 196 g/cm (500 g/in), and/or greater than about 236 g/cm (600 g/in), and/or greater than about 276 g/cm (700 g/in), and/or greater than about 315 g/cm (800 g/in), and/or greater than about 354 g/cm (900 g/in), and/or greater than about 394 g/cm (1000 g/in), and/or about 315 g/cm (800 g/in) to about 1968 g/cm (5000 g/in), and/or about 354 g/cm (900 g/in) to about 1181 g/cm (3000 g/in), and/or about 354 g/cm (900 g/in) to about 984 g/cm (2500 g/in), and/or about 394 g/cm (1000 g/in) to about 787 g/cm (2000 g/in).

The sanitary tissue described herein can exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue described herein can exhibit an initial total wet tensile strength of greater than about 118 g/cm (300 g/in), and/or greater than about 157 g/cm (400 g/in), and/or greater than about 196 g/cm (500 g/in), and/or greater than about 236 g/cm (600 g/in), and/or greater than about 276 g/cm (700 g/in), and/or greater than about 315 g/cm (800 g/in), and/or greater than about 354 g/cm (900 g/in), and/or greater than about 394 g/cm (1000 g/in), and/or about 118 g/cm (300 g/in) to about 1968 g/cm (5000 g/in), and/or about 157 g/cm (400 g/in) to about 1181 g/cm (3000 g/in), and/or about 196 g/cm (500 g/in) to about 984 g/cm (2500 g/in), and/or about 196 g/cm (500 g/in) to about 787 g/cm (2000 g/in), and/or about 196 g/cm (500 g/in) to about 591 g/cm (1500 g/in).

The sanitary tissue described herein can exhibit a density (measured at 95 g/in²) of less than about 0.60 g/cm³, and/or less than about 0.30 g/cm³, and/or less than about 0.20 g/cm³, and/or less than about 0.10 g/cm³, and/or less than about 0.07 g/cm³, and/or less than about 0.05 g/cm³, and/or about 0.01 g/cm³ to about 0.20 g/cm³, and/or about 0.02 g/cm³ to about 0.10 g/cm³.

The sanitary tissue described herein can exhibit a total absorptive capacity according to the Horizontal Full Sheet (HFS) Test Method described herein of greater than about 10 g/g, and/or greater than about 12 g/g, and/or greater than about 15 g/g, and/or about 15 g/g to about 50 g/g, and/or to about 40 g/g, and/or to about 30 g/g.

The sanitary tissue products described herein can exhibit a Vertical Full Sheet (VFS) value as determined by the Vertical Full Sheet (VFS) Test Method described herein of greater than about 5 g/g, and/or greater than about 7 g/g, and/or greater than about 9 g/g, and/or about 9 g/g to about 30 g/g, and/or to about 25 g/g, and/or to about 20 g/g, and/or to about 17 g/g.

The sanitary tissue described herein can be in the form of sanitary tissue product rolls. Such sanitary tissue product rolls may comprise a plurality of connected, but perforated sheets of fibrous structure that are separably dispensable from adjacent sheets. In one example, one or more ends of the roll of sanitary tissue product may comprise an adhesive and/or dry strength agent to mitigate the loss of fibers, especially wood pulp fibers, from the ends of the roll of sanitary tissue product.

The sanitary tissue described herein can comprise one or more additives, as previously described herein, such as softening agents, temporary wet strength agents, permanent wet strength agents, bulk softening agents, lotions, silicones, wetting agents, latexes (e.g., surface-pattern-applied latexes), dry strength agents (e.g., carboxymethylcellulose and starch), and other types of additives suitable for inclusion in and/or on a sanitary tissue.

### Wipe

The fibrous structure described herein may be utilized to form a wipe, for example a wet wipe. “Wipe” may be a general term to describe a piece of material, generally non-woven material, used in cleansing hard surfaces, food, inanimate objects, toys and body parts. In particular, many currently available wipes may be intended for the cleansing of the perianal area after defecation. Other wipes may be available for the cleansing of the face or other body parts. Multiple wipes may be attached together by any suitable method to form a mitt.

The material from which a wipe is made should be strong enough to resist tearing during normal use, yet still provide softness to the user's skin, such as a child's tender skin. Additionally, the material should be at least capable of retaining its form for the duration of the user's cleansing experience.

Wipes may be generally of sufficient dimension to allow for convenient handling. Typically, the wipe may be cut and/or folded to such dimensions as part of the manufacturing process. In some instances, the wipe may be cut into individual portions so as to provide separate wipes which are often stacked and interleaved in consumer packaging. In other embodiments, the wipes may be in a web form where the web has been slit and folded to a predetermined width and provided with means (e.g., perforations) to allow individual wipes to be separated from the web by a user. Suitably, an individual wipe may have a length between about 100 mm and about 250 mm and a width between about 140 mm and about 250 mm. In one embodiment, the wipe may be about 200 mm long and about 180 mm wide, and/or about 180 mm long and about 180 mm wide, and/or about 170 mm long and about 180 mm wide, and/or about 160 mm long and about 175 mm wide. The material of the wipe may generally be soft and flexible, potentially having a structured surface to enhance its cleaning performance.

It is also within the scope of the present invention that the wipe may be a laminate of two or more materials. Commercially available laminates, or purposely built laminates would be within the scope of the present invention. The laminated materials may be joined or bonded together in any suitable fashion, such as, but not limited to, ultrasonic bonding, adhesive, glue, fusion bonding, heat bonding, thermal bonding and combinations thereof. In another alternative embodiment the wipe may be a laminate comprising one or more layers of nonwoven materials and one or more layers of film. Examples of such optional films, include, but are not limited to, polyolefin films, such as, polyethylene film. In some preferred embodiments, the optional films are derived from renewable materials. An illustrative, but non-limiting example of a nonwoven material is a laminate of a 16 gsm nonwoven polypropylene and a 0.8 mm 20 gsm polyethylene film.

The wipes may also be treated to improve the softness and texture thereof by processes such as hydroentanglement or spunlacing. The wipes may be subjected to various treatments, such as, but not limited to, physical treatment, such as ring rolling, as described in U.S. Pat. No. 5,143,679, incorporated herein by reference; structural elongation, as described in U.S. Pat. No. 5,518,801, incorporated herein by reference; consolidation, as described in U.S. Pat. Nos. 5,914,084, 6,114,263, 6,129,801 and 6,383,431, each incorporated herein by reference; stretch aperturing, as described in U.S. Pat. Nos. 5,628,097, 5,658,639 and 5,916,661, each incorporated herein by reference; differential elongation, as described in WO Publication No. 2003/0028165A1, incorporated herein by reference; and other solid state formation technologies as described in U.S. Publication No. 2004/0131820A1 and U.S. Publication No. 2004/0265534A1, each incorporated herein by reference, and zone activation and the like; chemical treatment, such as, but not limited to, rendering part or all of the substrate hydrophobic, and/or hydrophilic, and the like; thermal treatment, such as, but not limited to, softening of fibers by heating, thermal bonding and the like; and combinations thereof.

The wipe may have a basis weight of at least about 30 grams/m², and/or at least about 35 grams/m², and/or at least about 40 grams/m². In one example, the wipe may have a basis weight of at least about 45 grams/m². In another example, the wipe basis weight may be less than about 100 grams/m². In another example, wipes may have a basis weight between about 45 grams/m² and about 75 grams/m², and in yet another embodiment a basis weight between about 45 grams/m² and about 65 grams/m².

In one example of the present invention the surface of wipe may be essentially flat. In another example of the present invention the surface of the wipe may optionally contain raised and/or lowered portions. These can be in the form of logos, indicia, trademarks, geometric patterns, images of the surfaces that the substrate is intended to clean (i.e., infant's body, face, etc.). They may be randomly arranged on the surface of the wipe or be in a repetitive pattern of some form.

In one example of the present invention, the fibrous structure comprises a pre-moistened wipe, such as a baby wipe. A plurality of the pre-moistened wipes may be stacked one on top of the other and may be contained in a container, such as a plastic tub or a film wrapper. In one example, the stack of pre-moistened wipes (typically about 40 to 80 wipes/stack) may exhibit a height of from about 50 to about 300 mm, and/or about 75 to about 125 mm. The pre-moistened wipes may comprise a liquid composition, such as a lotion. The pre-moistened wipes may be stored long term in a stack in a liquid impervious container or film pouch without all of the lotion draining from the top of the stack to the bottom of the stack. The pre-moistened wipes may exhibit a Liquid Absorptive Capacity of at least 2.5 g/g, and/or at least 4.0 g/g, and/or at least 7 g/g, and/or at least 12 g/g, and/or at least 13 g/g, and/or at least 13.5 g/g, and/or to about 30.0 g/g, and/or to about 20 g/g, and/or to about 15.0 g/g, as measured according to the Liquid Absorptive Capacity Test Method described herein.

In another example, the pre-moistened wipes may exhibit a saturation loading (g liquid composition to g of dry wipe) of about 1.5 to about 6.0 g/g. The liquid composition may exhibit a surface tension of about 20 to about 35 and/or about 28 to about 32 dynes/cm. The pre-moistened wipes may exhibit a dynamic absorption time (DAT) of about 0.01 to about 0.4, and/or about 0.01 to about 0.2, and/or about 0.03 to about 0.1 seconds, as measured according to the Dynamic Absorption Time Test Method described herein.

In one example, the pre-moistened wipes are present in a stack of pre-moistened wipes that exhibits a height of about 50 to about 300 mm, and/or about 75 to about 200 mm, and/or about 75 to about 125 mm, wherein the stack of pre-moistened wipes exhibits a saturation gradient index of about 1.0 to about 2.0, and/or about 1.0 to about 1.7. and/or about 1.0 to about 1.5.

To further illustrate the fibrous structures described herein, Table 1 sets forth properties of known and/or commercially available fibrous structures and three examples of fibrous structures in accordance with the present invention.

TABLE 1

| | | | | | | | CD Wet | | |
|---|---|---|---|---|---|---|---|---|---|
| | | | | | | | Initial | 43% or | 30% or |
| | | Basis | Liquid Abs. | Lotion | Soil Leak | | Tensile | more of pores | more of pores |
| | Contains | Wt. | Capacity | Release (g) | Through | | Strength | between 91 | between 121 |
| | Filament | [gsm] | [g/g] | [g] | Lr Value | SGI | [N/5 cm] | and 140 μm | and 200 μm |
| Invention | Yes | 61.1 | 13.6 | 0.279 | 1.0 | 1.21 | 8.7 | Yes | Yes |
| Invention | Yes | 44.1 | 14.8 | 0.333 | 1.7 | 1.11 | 6.6 | Yes | Yes |
| Invention | Yes | 65.0 | 16.0 | 0.355 | 0.9 | 1.21 | 6.0 | No | Yes |
| Huggies ® | Yes | 64.0 | 11.5 | 0.277 | 0.0 | 1.05 | 5.1 | No | No |
| Natural Care | | | | | | | | | |
| Huggies ® | Yes | 62.5 | 9.78 | 0.268 | 0.0 | 1.34 | 3.8 | No | No |
| Natural Care | | | | | | | | | |
| Bounty ® | No | 43.4 | 12.0 | — | 2.0 | — | — | No | No |
| Paper Towel | | | | | | | | | |
| Pampers ® | No | 57.4 | 12.0 | 0.281 | 19.2 | <1.5 | 12.5 | Yes | No |
| Baby Fresh | | | | | | | | | |
| Pampers ® | No | 57.7 | 7.32 | 0.258 | 8.7 | 1.20 | 11.3 | No | Yes |
| Baby Fresh | | | | | | | | | |
| Pampers ® | No | 67.1 | 7.52 | 0.285 | 4.3 | 1.32 | 8.2 | No | No |
| Thickcare | | | | | | | | | |

Table 2 sets forth the average pore volume distributions of known and/or commercially available fibrous structures and three examples of fibrous structures in accordance with the present invention.

TABLE 2

| Pore | | | | | Pampers ® | Pampers ® | | |
|---|---|---|---|---|---|---|---|---|
| Radius | | Huggies ® | | Bounty ® | Baby Fresh | Sensitive Wipes | | |
| (micron) | Huggies ® | Wash Cloth | Duramax | (no filaments) | (no filaments) | (no filaments) | Invention | Invention |
| 2.5 | 0 | 0 | 0 | 0 | 0 | 0 | 0 | 0 |
| 5 | 0 | 3.65 | 5.4 | 5.15 | 3.65 | 2.85 | 4.15 | 3.1 |
| 10 | 3.05 | 3.95 | 19.85 | 24.15 | 1.25 | 0.85 | 1.3 | 0.6 |
| 15 | 1.85 | 0.95 | 95.6 | 46.2 | 0 | 0 | 0 | 0 |
| 20 | 0 | 0 | 53.95 | 27.95 | 0 | 0 | 0 | 0 |
| 30 | 13.65 | 0 | 73.85 | 36.3 | 0 | 0 | 0 | 0 |
| 40 | 85.45 | 0 | 57.15 | 22.85 | 0 | 0 | 0 | 0 |
| 50 | 116.95 | 0 | 61.25 | 27.5 | 0 | 0 | 0 | 0 |
| 60 | 196.5 | 92.95 | 66.9 | 35.3 | 12.75 | 1.2 | 17.15 | 16.45 |
| 70 | 299.15 | 141.55 | 58.35 | 33 | 25.55 | 3.05 | 65.75 | 44.7 |
| 80 | 333.8 | 129.25 | 52.95 | 30.8 | 32.45 | 7 | 83.2 | 72.4 |
| 90 | 248.15 | 148.05 | 46.55 | 30.25 | 56.7 | 30.75 | 111.65 | 104.8 |
| 100 | 157.55 | 160.2 | 45.7 | 29.6 | 112.7 | 56.1 | 169.4 | 152.8 |
| 120 | 168.05 | 389.35 | 90.85 | 59.95 | 858.65 | 306.15 | 751.65 | 626.85 |
| 140 | 81.6 | 448.2 | 86 | 65 | 427.05 | 600.4 | 873.85 | 556.95 |
| 160 | 50.6 | 502.05 | 73.2 | 71.4 | 40.25 | 666.05 | 119.3 | 64.65 |
| 180 | 34.05 | 506.45 | 60.2 | 75.25 | 18.3 | 137.9 | 20.15 | 16.95 |
| 200 | 27.2 | 448 | 47.05 | 86.25 | 10.5 | 31.95 | 14.7 | 11.9 |
| 225 | 23.9 | 404.85 | 47.3 | 130.1 | 8.8 | 14.1 | 15.15 | 12.45 |
| 250 | 19.85 | 242.2 | 41 | 146.8 | 10.3 | 10.65 | 14.8 | 12.35 |
| 275 | 18.05 | 140 | 36.15 | 153.8 | 6.15 | 7.25 | 12.1 | 10.2 |
| 300 | 15.7 | 98.6 | 33.25 | 123 | 5.85 | 6.2 | 13.65 | 9.55 |
| 350 | 22.9 | 146.15 | 53.65 | 137.95 | 9.6 | 10.1 | 21.15 | 16.2 |
| 400 | 17.8 | 135.25 | 52.8 | 45.95 | 8.9 | 8.45 | 17.6 | 19.15 |
| 500 | 33.5 | 259.05 | 254.35 | 43.9 | 14.55 | 13.5 | 38.1 | 33.65 |
| 600 | 21.85 | 218.5 | 279.45 | 11.45 | 14.45 | 12.7 | 56.85 | 23 |
| 800 | 20.05 | 235 | 135.8 | 8.3 | 61.45 | 108 | 59.05 | 33.05 |
| 1000 | 9.2 | 83 | 0 | 0 | 23.25 | 36.75 | 47.95 | 52.95 |
| Total (mg) | 2020.4 | 4937.2 | 1928.55 | 1508.15 | 1763.1 | 2071.95 | 2528.65 | 1894.7 |

| | | | | | | | | |
|---|---|---|---|---|---|---|---|---|
| 91-140 | 20.2% | 20.2% | 11.5% | 10.2% | 79.3% | 46.5% | 71.0% | 70.5% |
| Pore Range | | | | | | | | |
| 101-200 | 18% | 46% | 19% | 24% | 77% | 84% | 70% | 67% |
| Pore Range | | | | | | | | |
| 121-200 | 10% | 39% | 14% | 20% | 28% | 69% | 41% | 34% |
| Pore Range | | | | | | | | |
| 141-225 | 7% | 38% | 12% | 24% | 4% | 41% | 7% | 6% |
| Pore Range | | | | | | | | |

| | | Pampers ® | Pampers ® | |
|---|---|---|---|---|
| Pore Radius | | Thickcare | Baby Fresh | |
| (micron) | Huggies ® | (no filaments) | (no filaments) | Invention |
| 2.5 | 0 | 0 | 0 | 0 |
| 5 | 5.1 | 5.2 | 4.5 | 5.5 |
| 10 | 3.3 | 3.3 | 2.2 | 2.6 |
| 15 | 2 | 2.4 | 0.8 | 2 |
| 20 | 2.1 | 1.2 | 2 | 0.7 |
| 30 | 8.5 | 12.3 | 0.8 | 1.7 |
| 40 | 39.6 | 43.3 | 4.3 | 3.3 |
| 50 | 98.3 | 83.6 | 2.5 | 0.7 |
| 60 | 70.2 | 107.3 | 2.8 | 2.1 |
| 70 | 118.2 | 174.2 | 6 | 1.4 |
| 80 | 156.9 | 262.4 | 19.5 | 1.9 |
| 90 | 255.3 | 297.4 | 9.8 | 1.8 |
| 100 | 342.1 | 188.7 | 17 | 7.5 |
| 120 | 396.3 | 168.8 | 38.4 | 80.4 |
| 140 | 138.3 | 55.9 | 69.7 | 306.9 |
| 160 | 70.5 | 22.8 | 133.1 | 736 |
| 180 | 45.8 | 16.7 | 448.1 | 1201.1 |
| 200 | 28.3 | 13.8 | 314.2 | 413 |
| 225 | 31.9 | 16.5 | 362.2 | 131.5 |
| 250 | 30.5 | 11.7 | 206.6 | 55.6 |
| 275 | 26.4 | 11.9 | 138.3 | 24.9 |
| 300 | 23.8 | 11.9 | 78.7 | 13.6 |
| 350 | 37.4 | 18.9 | 77.1 | 23.3 |
| 400 | 28.5 | 16.5 | 37.6 | 20 |
| 500 | 44.2 | 24.2 | 37.9 | 30.3 |
| 600 | 27.6 | 28.8 | 32.6 | 24.5 |
| 800 | 41.1 | 66.5 | 35.3 | 39.5 |
| 1000 | 24.7 | 32 | 16.3 | 27.9 |
| Total (mg) | 2096.9 | 1698.2 | 2098.3 | 3159.7 |

| | | | | |
|---|---|---|---|---|
| 91-140 | 41.8% | 24.3% | 6.0% | 12.5% |
| Pore Range | | | | |
| 101-200 | 32% | 16% | 48% | 87% |
| Pore Range | | | | |
| 121-200 | 13% | 6% | 46% | 84% |
| Pore Range | | | | |
| 141-225 | 8% | 4% | 60% | 79% |
| Pore Range | | | | |

### Test Methods

### Assessment of the Biobased Content of Materials

A suitable method to assess materials derived from renewable resources is through ASTM D6866, which allows the determination of the biobased content of materials using radiocarbon analysis by accelerator mass spectrometry, liquid scintillation counting, and isotope mass spectrometry. When nitrogen in the atmosphere is struck by an ultraviolet light produced neutron, it loses a proton and forms carbon that has a molecular weight of 14, which is radioactive. This ¹⁴C is immediately oxidized into carbon dioxide, which represents a small, but measurable fraction of atmospheric carbon. Atmospheric carbon dioxide is cycled by green plants to make organic molecules during the process known as photosynthesis. The cycle is completed when the green plants or other forms of life metabolize the organic molecules producing carbon dioxide, which causes the release of carbon dioxide back to the atmosphere. Virtually all forms of life on Earth depend on this green plant production of organic molecules to produce the chemical energy that facilitates growth and reproduction. Therefore, the ¹⁴C that exists in the atmosphere becomes part of all life forms and their biological products. These renewably based organic molecules that biodegrade to carbon dioxide do not contribute to global warming because no net increase of carbon is emitted to the atmosphere. In contrast, fossil fuel-based carbon does not have the signature radiocarbon ratio of atmospheric carbon dioxide. See WO 2009/155086, incorporated herein by reference.

The application of ASTM D6866 to derive a “biobased content” is built on the same concepts as radiocarbon dating, but without use of the age equations. The analysis is performed by deriving a ratio of the amount of radiocarbon (¹⁴C) in an unknown sample to that of a modern reference standard. The ratio is reported as a percentage with the units “pMC” (percent modem carbon). If the material being analyzed is a mixture of present day radiocarbon and fossil carbon (containing no radiocarbon), then the pMC value obtained correlates directly to the amount of biomass material present in the sample.

The modem reference standard used in radiocarbon dating is a NIST (National Institute of Standards and Technology) standard with a known radiocarbon content equivalent approximately to the year AD 1950. The year AD 1950 was chosen because it represented a time prior to thermo-nuclear weapons testing, which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. The distribution of bomb carbon has gradually decreased over time, with today's value being near 107.5 pMC. As a result, a fresh biomass material, such as corn, could result in a radiocarbon signature near 107.5 pMC.

Petroleum-based carbon does not have the signature radiocarbon ratio of atmospheric carbon dioxide. Research has noted that fossil fuels and petrochemicals have less than about 1 pMC, and typically less than about 0.1 pMC, for example, less than about 0.03 pMC. However, compounds derived entirely from renewable resources have at least about 95 percent modern carbon (pMC), and/or at least about 99 pMC, for example, about 100 pMC.

Combining fossil carbon with present day carbon into a material will result in a dilution of the present day pMC content. By presuming that 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, it would give a radiocarbon signature near 54 pMC.

A biobased content result is derived by assigning 100% equal to 107.5 pMC and 0% equal to 0 pMC. In this regard, a sample measuring 99 pMC will give an equivalent biobased content result of 93%.

Assessment of the materials described herein were done in accordance with ASTM D6866, particularly with Method B. The mean values quoted in this report encompasses an absolute range of 6% (plus and minus 3% on either side of the biobased content value) to account for variations in end-component radiocarbon signatures. It is presumed that all materials are present day or fossil in origin and that the desired result is the amount of biobased component “present” in the material, not the amount of biobased material “used” in the manufacturing process.

Other techniques for assessing the biobased content of materials are described in U.S. Pat. Nos. 3,885,155, 4,427,884, 4,973,841, 5,438,194, and 5,661,299, and WO 2009/155086, each incorporated herein by reference.

### Characterization of Fibrous Structures

Unless otherwise indicated, all tests described herein are conducted on samples that have been conditioned in a conditioned room at a temperature of 73° F.±4° F. (about 23° C.±2.2° C.) and a relative humidity of 50%±10% for 2 hours prior to the test. Samples conditioned as described herein are considered dry samples (i.e., “dry fibrous structures”) for purposes of this invention. Further, all tests are conducted in such conditioned room.

### A. Pore Volume Distribution Test Method

Pore Volume Distribution measurements are made on a TRI/Autoporosimeter (TRI/Princeton Inc. of Princeton, N.J.). The TRI/Autoporosimeter is an automated computer-controlled instrument for measuring pore volume distributions in porous materials (e.g., the volumes of different size pores within the range of about 1 to about 1000 μm effective pore radii). Complimentary Automated Instrument Software, Release 2000.1, and Data Treatment Software, Release 2000.1 is used to capture, analyze and output the data. More information on the TRI/Autoporosimeter, its operation and data treatments can be found in The Journal of Colloid and Interface Science 162:163-170 (1994), incorporated here by reference.

As used herein, determining Pore Volume Distribution involves recording the increment of liquid that enters a porous material as the surrounding air pressure changes. A sample in the test chamber is exposed to precisely controlled changes in air pressure. The size (radius) of the largest pore able to hold liquid is a function of the air pressure. As the air pressure increases, different size pore groups drain liquid, and as the air pressure decreases, different size pore groups absorb liquid. The pore volume of each group is equal to this amount of liquid, as measured by the instrument at the corresponding pressure. The effective radius of a pore is related to the pressure differential by the following relationship.

Pressure differential=[(2)γ cos θ)]/effective radius

where γ=liquid surface tension, and θ=contact angle.

Typically pores are thought of in terms such as voids, holes, or conduits in a porous material. It is important to note that this method uses the above equation to calculate effective pore radii based on the constants and equipment controlled pressures. The above equation assumes uniform cylindrical pores. Usually, the pores in natural and manufactured porous materials are not perfectly cylindrical, nor all uniform. Therefore, the effective radii reported here may not equate exactly to measurements of void dimensions obtained by other methods such as microscopy. However, these measurements do provide an accepted means to characterize relative differences in void structure between materials.

The equipment operates by changing the test chamber air pressure in user-specified increments, either by decreasing pressure (increasing pore size) to absorb liquid, or increasing pressure (decreasing pore size) to drain liquid. The liquid volume absorbed (drained) at each pressure increment is the cumulative volume for the group of all pores between the preceding pressure setting and the current setting.

In this application of the TRI/Autoporosimeter, the liquid is a 0.2 wt. % solution of octylphenoxy polyethoxy ethanol (Triton X-100 from Union Carbide Chemical and Plastics Co. of Danbury, Conn.) in distilled water. The instrument calculation constants are as follows: p (density)=1 g/cm³; γ (surface tension)=31 dynes/cm; cos θ=1. A 0.22 μm Millipore Glass Filter (Millipore Corporation of Bedford, Mass.; Catalog #GSWP09025) is employed on the test chamber's porous plate. A plexiglass plate weighing about 24 g (supplied with the instrument) is placed on the sample to ensure the sample rests flat on the Millipore Filter. No additional weight is placed on the sample.

The remaining user specified inputs are described below. The sequence of pore sizes (pressures) for this application is as follows (effective pore radius in μm): 1, 2.5, 5, 10, 15, 20, 30, 40, 50, 60, 70, 80, 90, 100, 120, 140, 160, 180, 200, 225, 250, 275, 300, 350, 400, 500, 600, 800, 1000. This sequence starts with the sample dry, saturates it as the pore settings increase (typically referred to with respect to the procedure and instrument as the 1^{st} absorption).

In addition to the test materials, a blank condition (no sample between plexiglass plate and Millipore Filter) is run to account for any surface and/or edge effects within the chamber. Any pore volume measured for this blank run is subtracted from the applicable pore grouping of the test sample. This data treatment can be accomplished manually or with the available TRI/Autoporosimeter Data Treatment Software, Release 2000.1.

Percent (%) Total Pore Volume is a percentage calculated by taking the volume of fluid in the specific pore radii range divided by the total pore volume. The TRI/Autoporosimeter outputs the volume of fluid within a range of pore radii. The first data obtained is for the “2.5 micron” pore radii which includes fluid absorbed between the pore sizes of 1 to 2.5 micron radius. The next data obtained is for “5 micron” pore radii, which includes fluid absorbed between the 2.5 micron and 5 micron radii, and so on. Following this logic, to obtain the volume held within the range of 101-200 micron radii, one would sum the volumes obtained in the range titled “120 micron”, “140 micron”, “160 micron”, “180 micron”, and finally the “200 micron” pore radii ranges. For example, % Total Pore Volume 101-200 micron pore radii=(volume of fluid between 101-200 micron pore radii)/Total Pore Volume

### B. Horizontal Full Sheet (HFS) Test Method

The Horizontal Full Sheet (HFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a horizontal position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the HFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested (i.e.; a fibrous structure sample of about 11 in. (27.9 cm) by 11 in. (27.9 cm)). The balance pan can be made out of a variety of materials. Plexiglass is a common material used.

2) A sample support rack and sample support rack cover is also required. Both the rack and cover are comprised of a lightweight metal frame, strung with 0.012 in. (0.305 cm) diameter monofilament so as to form a grid. The size of the support rack and cover is such that the sample size can be conveniently placed between the two.

The HFS test is performed in an environment maintained at 23±1° C. and 50±2% relative humidity. A water reservoir or tub is filled with distilled water at 23±1° C. to a depth of 3 inches (7.6 cm).

Eight samples of a fibrous structure to be tested are carefully weighed on the balance to the nearest 0.01 grams. The dry weight of each sample is reported to the nearest 0.01 grams. The empty sample support rack is placed on the balance with the special balance pan described above. The balance is then zeroed (tared). One sample is carefully placed on the sample support rack. The support rack cover is placed on top of the support rack. The sample (now sandwiched between the rack and cover) is submerged in the water reservoir. After the sample is submerged for 60 seconds, the sample support rack and cover are gently raised out of the reservoir.

The sample, support rack and cover are allowed to drain horizontally for 120±5 seconds, taking care not to excessively shake or vibrate the sample. While the sample is draining, the rack cover is carefully removed and all excess water is wiped from the support rack. The wet sample and the support rack are weighed on the previously tared balance. The weight is recorded to the nearest 0.01 g. This is the wet weight of the sample.

The gram per fibrous structure sample absorptive capacity of the sample is defined as (wet weight of the sample−dry weight of the sample). The horizontal absorbent capacity (HAC) is defined as: absorbent capacity=(wet weight of the sample−dry weight of the sample)/(dry weight of the sample) and has a unit of gram/gram.

### C. Vertical Full Sheet (VFS) Test Method

The Vertical Full Sheet (VFS) test method determines the amount of distilled water absorbed and retained by a fibrous structure. This method is performed by first weighing a sample of the fibrous structure to be tested (referred to herein as the “dry weight of the sample”), then thoroughly wetting the sample, draining the wetted sample in a vertical position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the VFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested (i.e.; a fibrous structure sample of about 11 in. (27.9 cm) by 11 in. (27.9 cm)). The balance pan can be made out of a variety of materials. Plexiglass is a common material used.

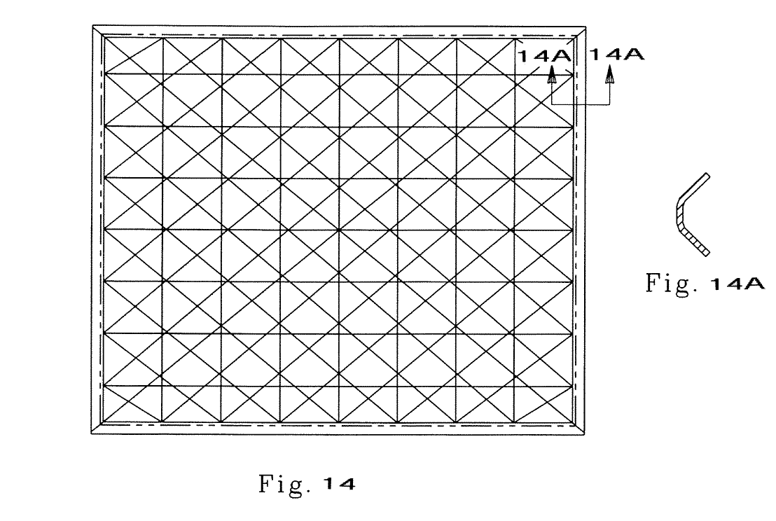

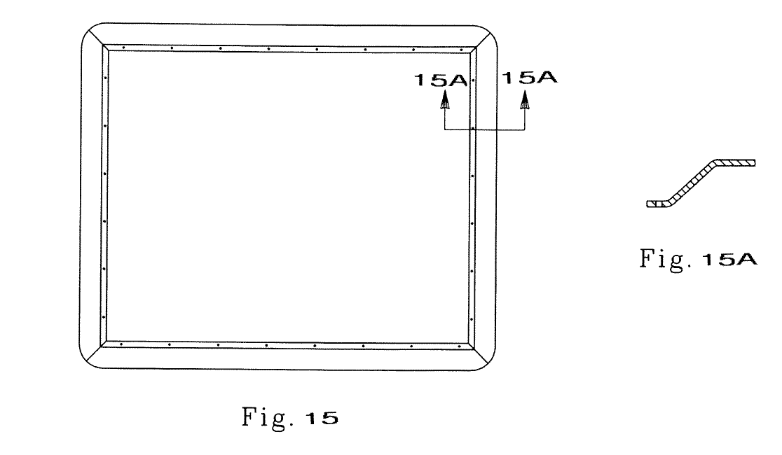

2) A sample support rack (FIGS. 14 and 14A) and sample support rack cover (FIGS. 15 and 15A) is also required. Both the rack and cover are comprised of a lightweight metal frame, strung with 0.012 in. diameter monofilament so as to form a grid as shown in FIG. 14. The size of the support rack and cover is such that the sample size can be conveniently placed between the two.

The VFS test is performed in an environment maintained at 23±1° C. and 50±2% relative humidity. A water reservoir or tub is filled with distilled water at 23±1° C. to a depth of 3 inches (7.6 cm).

Eight 19.05 cm (7.5 inch)×19.05 cm (7.5 inch) to 27.94 cm (11 inch)×27.94 cm (11 inch) samples of a fibrous structure to be tested are carefully weighed on the balance to the nearest 0.01 grams. The dry weight of each sample is reported to the nearest 0.01 grams. The empty sample support rack is placed on the balance with the special balance pan described above. The balance is then zeroed (tared). One sample is carefully placed on the sample support rack. The support rack cover is placed on top of the support rack. The sample (now sandwiched between the rack and cover) is submerged in the water reservoir. After the sample is submerged for 60 seconds, the sample support rack and cover are gently raised out of the reservoir.

The sample, support rack, and cover are allowed to drain vertically for 60±5 seconds, taking care not to excessively shake or vibrate the sample. While the sample is draining, the rack cover is carefully removed and all excess water is wiped from the support rack. The wet sample and the support rack are weighed on the previously tared balance. The weight is recorded to the nearest 0.01 g. This is the wet weight of the sample.

The procedure is repeated with another sample of the fibrous structure, however, the sample is positioned on the support rack such that the sample is rotated 90° compared to the position of the first sample on the support rack.

The gram per fibrous structure sample absorptive capacity of the sample is defined as (wet weight of the sample−dry weight of the sample). The calculated VFS is the average of the absorptive capacities of the two samples of the fibrous structure.

### D. Basis Weight Test Method

Basis weight of a fibrous structure and/or sanitary tissue product sample is measured by selecting twelve (12) usable units (also referred to as sheets) of the fibrous structure and making two stacks of six (6) usable units each. Perforation must be aligned on the same side when stacking the usable units. A precision cutter is used to cut each stack into exactly 8.89 cm×8.89 cm (3.5 in.×3.5 in.) squares. The two stacks of cut squares are combined to make a basis weight pad of twelve (12) squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$${Basis Weight}_{( lbs \text{/} 3000 {ft}^{2} )} = \frac{Weight of basis weight pad ( g ) \times 3000 {ft}^{3}}{\begin{matrix}453.6 g \text{/} lbs \times 12 ( usable units ) \times \\ [ 12.25 {in}^{2} ( Area of basis weight pad ) \text{/} 144 {in}^{2} ]\end{matrix}}$$

$${Basis Weight}_{( g \text{/} {m}^{2} )} = \frac{Weight of basis weight pad ( g ) \times 10 , 000 {cm}^{2} \text{/} {m}^{2}}{\begin{matrix}79.0321 {cm}^{2} ( Area of basis weight pad ) \times \\ 12 ( usable units )\end{matrix}}$$

### E. Dry Burst Test Method

Fibrous structure samples for each condition to be tested are cut to a size appropriate for testing (minimum sample size 4.5 inches×4.5 inches), a minimum of five (5) samples for each condition to be tested are prepared.

A burst tester (Burst Tester Intelect-II-STD Tensile Test Instrument, Cat. No. 1451-24PGB available from Thwing-Albert Instrument Co., Philadelphia, Pa.) is set up according to the manufacturer's instructions and the following conditions: Speed: 12.7 centimeters per minute; Break Sensitivity: 20 grams; and Peak Load: 2000 grams. The load cell is calibrated according to the expected burst strength.

A fibrous structure sample to be tested is clamped and held between the annular clamps of the burst tester and is subjected to increasing force that is applied by a 0.625 inch diameter, polished stainless steel ball upon operation of the burst tester according to the manufacturer's instructions. The burst strength is that force that causes the sample to fail.

The burst strength for each fibrous structure sample is recorded. An average and a standard deviation for the burst strength for each condition is calculated.

The Dry Burst is reported as the average and standard deviation for each condition to the nearest gram.

### F. Elongation, Tensile Strength, TEA and Modulus Test Methods

Fours stacks of fibrous structures, dry or wet depending on the property being measured, are prepared using five samples each. The samples are oriented the same way in each stack with respect to MD:CD. (Fibrous structures which lack MD:CD orientation are used without this distinction.) The sample size is sufficient for the tests described below. Two of the stacks are marked for testing in the MD and two for CD. A total of 8 strips are obtained by cutting 4 samples in the MD and 4 samples in the CD of dimensions 1.00″ wide (2.54 cm) and 3.00″ long.

An EJA tensile tester (or equivalent) (Thwing-Albert Instrument Co. of Philadelphia, Pa.) equipped with flat face clamps (calibrated according to the instructions given in the operation manual of the EJA) is used for the measurements. The crosshead speed is set to 4.00 in/min (10.16 cm/min). The break sensitivity is set to 20.0 grams and the sample width is set to 1.00 inch (2.54 cm) and the sample thickness is set to 0.3937 inch (1.00 cm). The energy units are set to TEA and the tangent modulus (Modulus) trap setting is set to 38.1 g.

The sample strips (1 inch wide by 5 samples thick) are placed in one end of it in one clamp of the tensile tester and the other in the other clamp, with the long dimension of the sample strip running parallel to the sides of the tensile tester. The gauge length is set to 2″ and the data sampling rate is set to 20 points/second.

After inserting the sample strip into the two clamps, the instrument tension can be monitored. If it shows a value of 11 g or more, the fibrous structure sample strip is too taut and the test needs to be re-run.

The test is initiated. When the tension reaches 11.2 g, which defines the zero point, measuring and collecting of tension data begins. The test is complete after the crosshead automatically returns to its initial starting position. When the test is complete, the following data are obtained and recorded:

Peak Load Tensile (Tensile Strength) (g/in)

Peak Elongation (Elongation) (%)

Peak TEA (TEA) (in-g/in²)

Tangent Modulus (Modulus) (at 15 g/cm)

Additional samples are tested the same manner

### Calculations:

### Geometric Mean (GM) Elongation=Square Root of [MD Elongation (%)×CD Elongation (%)]

Total Dry Tensile (TDT)=Peak Load MD Tensile (g/in)+Peak Load CD Tensile (g/in)
Tensile Ratio=Peak Load MD Tensile (g/in)/Peak Load CD Tensile (g/in)
Geometric Mean (GM) Tensile=[Square Root of (Peak Load MD Tensile (g/in)×Peak Load CD Tensile (g/in))]×3
TEA=MD TEA (g*in/in²)+CD TEA (g*in/in²)
Geometric Mean (GM) TEA=Square Root of [MD TEA (g*in/in²)×CD TEA (g*in/in²)]
Modulus=MD Modulus (g/cm*% at 15 g/cm)+CD Modulus (g/cm*% at 15 g/cm)
Geometric Mean (GM) Modulus=Square Root of [MD Modulus (g/cm*% at 15 g/cm)×CD Modulus (g/cm*% at 15 g/cm)]

### G. Liquid Absorptive Capacity

The following method, which is modeled after EDANA 10.4-02, is suitable to measure the Liquid Absorptive Capacity of any fibrous structure or wipe.

Prepare 5 samples of a pre-conditioned/conditioned fibrous structure or wipe for testing so that an average Liquid Absorptive Capacity of the 5 samples can be obtained.

### Materials/Equipment

1. Flat stainless steel wire gauze sample holder with handle (commercially available from Humboldt Manufacturing Company) and flat stainless steel wire gauze (commercially available from McMaster-Carr) having a mesh size of 20 and having an overall size of at least 120 mm×120 mm
2. Dish of size suitable for submerging the sample holder, with sample attached, in a test liquid, described below, to a depth of approximately 20 mm
3. Binder Clips (commercially available from Staples) to hold the sample in place on the sample holder
4. Ring stand
5. Balance, which reads to four decimal places
6. Stopwatch
7. Test liquid: deionized water (resistivity >18 megaohms·cm)

### Procedure

Prepare 5 samples of a fibrous structure or wipe for 5 separate Liquid Absorptive Capacity measurements. Individual test pieces are cut from the 5 samples to a size of approximately 100 mm×100 mm, and if an individual test piece weighs less than 1 gram, stack test pieces together to make sets that weigh at least 1 gram total. Fill the dish with a sufficient quantity of the test liquid described above, and allow it to equilibrate with room test conditions. Record the mass of the test piece(s) for the first measurement before fastening the test piece(s) to the wire gauze sample holder described above with the clips. While trying to avoid the creation of air bubbles, submerge the sample holder in the test liquid to a depth of approximately 20 mm and allow it to sit undisturbed for 60 seconds. After 60 seconds, remove the sample and sample holder from the test liquid. Remove all the binder clips but one, and attach the sample holder to the ring stand with the binder clip so that the sample may vertically hang freely and drain for a total of 120 seconds. After the conclusion of the draining period, gently remove the sample from the sample holder and record the sample's mass. Repeat for the remaining four test pieces or test piece sets.

### Calculation of Liquid Absorptive Capacity

Liquid Absorptive Capacity is reported in units of grams of liquid composition per gram of the fibrous structure or wipe being tested. Liquid Absorptive Capacity is calculated as follows for each test that is conducted:

$$LiquidAbsorptive Capacity = \frac{{M}_{x} - {M}_{i}}{{M}_{i}}$$

In this equation, Mᵢ is the mass in grams of the test piece(s) prior to starting the test, and M_{X} is the mass in grams of the same after conclusion of the test procedure. Liquid Absorptive Capacity is typically reported as the numerical average of at least five tests per sample.

### EXAMPLE

### Non-limiting Examples of Process for Making a Fibrous Structure of the Present Invention

### Process Example 1

A 95%:5% blend of bio-polypropylene:Polyvel S-1416 wetting agent is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air is heated such that the air exhibits a temperature of about 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at a temperature of about 85 to 90° F. and about 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction such that the pulp fibers are injected into the meltblown filaments in a perpendicular fashion (with respect to the flow of the meltblown filaments) through a 4 inch×15 inch cross-direction (CD) slot. A forming box surrounds the area where the meltblown filaments and pulp fibers are commingled. This forming box is designed to reduce the amount of air allowed to enter or escape from this commingling area; however, there is an additional 4 inch×15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

Optionally, a meltblown layer of the meltblown filaments, such as a scrim, can be added to one or both sides of the above formed fibrous structure. This addition of the meltblown layer can help reduce the lint created from the fibrous structure during use by consumers and may be performed prior to any thermal bonding operation of the fibrous structure. The meltblown filaments for the exterior layers can be the same or different than the meltblown filaments used on the opposite layer or in the center layer(s).

The fibrous structure may be convolutedly wound to form a roll of fibrous structure. The end edges of the roll of fibrous structure may be contacted with a material to create bond regions.

### Process Example 2

A 95%:5% blend of bio-polypropylene:Polyvel S-1416 wetting agent is dry blended, to form a melt blend. The melt blend is heated to about 405° F. through a melt extruder. A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 500 SCFM of compressed air is heated such that the air exhibits a temperature of about 395° F. at the spinnerette. Approximately 1000 g/minute of Golden Isle (from Georgia Pacific) 4825 semi-treated SSK pulp is defibrillated through a hammermill to form SSK wood pulp fibers (solid additive). Air at a temperature of about 90° F. and about 75% relative humidity (RH) is drawn into the hammermill. Approximately 2000 SCFM of air carries the pulp fibers to two solid additive spreaders. The solid additive spreaders turns the pulp fibers and distributes the pulp fibers in the cross-direction such that the pulp fibers are injected into the meltblown filaments in a perpendicular fashion (with respect to the flow of the filaments) through two 4 inch×15 inch cross-direction (CD) slots. A forming box surrounds the area where the meltblown filaments and pulp fibers are commingled. This forming box is designed to reduce the amount of air allowed to enter or escape from this commingling area. The two slots are oriented opposite of one another on opposite sides of the meltblown filament spinnerette. A forming vacuum pulls air through a collection device, such as a non-patterned forming belt or through-air-drying fabric, thus collecting the commingled meltblown filaments and pulp fibers to form a fibrous structure. The fibrous structure formed by this process comprises about 80% by dry fibrous structure weight of pulp and about 20% by dry fibrous structure weight of meltblown filaments.

Optionally, a meltblown layer of the meltblown filaments, such as a scrim, can be added to one or both sides of the above formed fibrous structure. This addition of the meltblown layer can help reduce the lint created from the fibrous structure during use by consumers and may be performed prior to any thermal bonding operation of the fibrous structure. The meltblown filaments for the exterior layers can be the same or different than the meltblown filaments used on the opposite layer or in the center layer(s).

The fibrous structure may be convolutedly wound to form a roll of fibrous structure. The end edges of the roll of fibrous structure may be contacted with a material to create bond regions.

### Process Example 3

A 95%:5% blend of bio-polypropylene:Polyvel S-1416 wetting agent is dry blended, to form a melt blend. The melt blend is heated to 475° F. through a melt extruder. A 10″ wide Biax 12 row spinnerette with 192 nozzles per cross-direction inch, commercially available from Biax Fiberfilm Corporation, is utilized. 32 nozzles per cross-direction inch of the 192 nozzles have a 0.018″ inside diameter while the remaining nozzles are solid, i.e. there is no opening in the nozzle. Approximately 0.17 grams per hole per minute (ghm) of the melt blend is extruded from the open nozzles to form meltblown filaments from the melt blend. Approximately 200 SCFM of compressed air is heated such that the air exhibits a temperature of 395° F. at the spinnerette. Approximately 175 grams/minute of Koch 4825 semi-treated SSK pulp is defibrillated through a hammermill to form SSK wood pulp fibers (solid additive). 330 SCFM of air at 85-90° F. and 85% relative humidity (RH) is drawn into the hammermill and carries the pulp fibers to a solid additive spreader. The solid additive spreader turns the pulp fibers and distributes the pulp fibers in the cross-direction such that the pulp fibers are injected into the meltblown filaments in a perpendicular fashion through a 2″×10″ cross-direction (CD) slot. A forming box surrounds the area where the meltblown filaments and pulp fibers are commingled. This forming box is designed to reduce the amount of air allowed to enter or escape from this commingling area; however, there is a 2″×12″ opening in the bottom of the forming box designed to permit additional cooling air to enter. A forming vacuum pulls air through a forming fabric thus collecting the commingled meltblown filaments and pulp fibers to form a fibrous structure. The forming vacuum is adjusted until an additional 400 SCFM of room air is drawn into the slot in the forming box. The fibrous structure formed by this process comprises about 75% by dry fibrous structure weight of pulp and about 25% by dry fibrous structure weight of meltblown filaments.

Any suitable material known in the art may be used to make the spreader. Non-limiting examples of suitable materials include non-conductive materials. For example, stainless steel and/or sheet metal may be used to fabricate the spreader. A pulp and air mixture created in the hammermill enters the spreader through a duct connecting the hammermill and spreader at greater than about 8,000 fpm velocity and/or greater than about 14,000 fpm. The inlet is tilted at an angle α at approximately 5° upstream from perpendicular of the exit. The exit of the solid additive spreader has a height H in the range of about 2.54 cm (1 inch) to about 25.40 cm (10 inches). The width W of the exit is about 1.27 cm (0.5 inch) to about 10.16 cm (4 inches). Typically the width W of the exit is about 5.08 cm (2 inches). The length L of the spreader is about 60.96 cm (24 inches) to about 243.84 cm (96 inches), and/or about 91.44 cm (36 inches) to about 182.88 cm (72 inches), and/or about 121.92 cm (48 inches) to about 152.40 cm (60 inches). A tapering of the height H of the spreader occurs from the inlet end to the exit end to continually accelerate the pulp and air mixture. This tapering is about 10.16 cm (4 inches) in height at the inlet to about 5.08 cm (2 inches) in height at the exit. However, the spreader may incorporate other similar taperings. The inlet end of the spreader has a semi-circular arc from the top view with a radius of from about 7.62 cm (3 inches) to about 50.80 cm (20 inches), and/or about 12.70 cm (5 inches) to about 25.40 cm (10 inches). Multiple semi-circular arcs can be assembled to produce the desired spreader width. Each semicircular arc would comprise its own inlet centered in each of these semi-circular arcs.

Optionally, a meltblown layer of the meltblown filaments can be added to one or both sides of the above formed fibrous structure. This addition of the meltblown layer can help reduce the lint created from the fibrous structure during use by consumers and may be performed prior to any thermal bonding operation of the fibrous structure. The meltblown filaments for the exterior layers can be the same or different than the meltblown filaments used on the opposite layer or in the center layer(s).

The fibrous structure may be convolutedly wound to form a roll of fibrous structure. The end edges of the roll of fibrous structure may be contacted with a material to create bond regions.

### Non-limiting Examples of Fibrous Structures

### Fibrous Structure Example 1

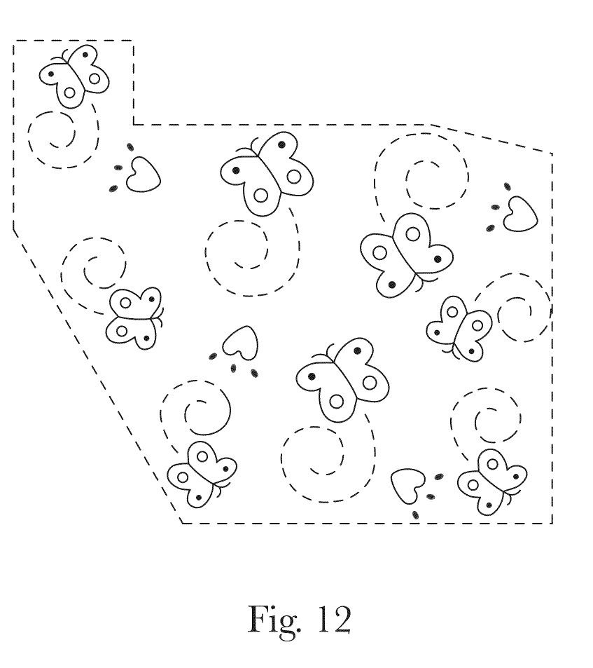

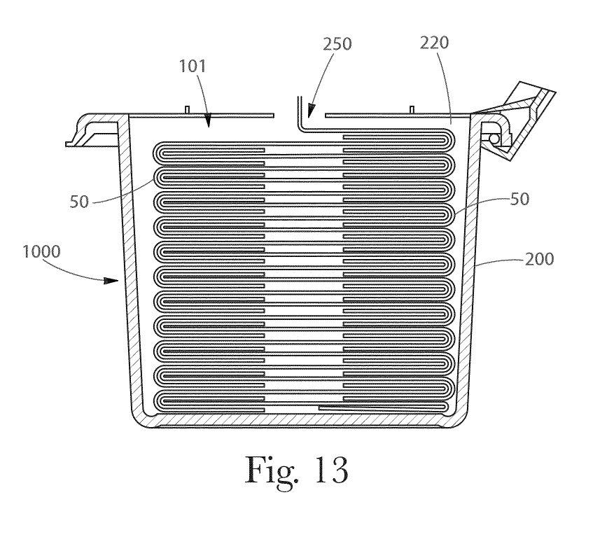

A pre-moistened wipe according to the present invention is prepared as follows. A fibrous structure of the present invention of about 44 g/m² that comprises a thermal bonded pattern as shown in FIG. 12 is saturation loaded with a liquid composition according to the present invention to an average saturation loading of about 358% of the basis weight of the wipe. The wipes are then Z-folded and placed in a stack to a height of about 82 mm as shown in FIG. 13.

### Fibrous Structure Example 2

A pre-moistened wipe according to the present invention is prepared as follows. A fibrous structure of the present invention of about 61 g/m² that comprises a thermal bonded pattern as shown in FIG. 12 is saturation loaded with a liquid composition according to the present invention to an average saturation loading of about 347% of the basis weight of the wipe. The wipes are then Z-folded and placed in a stack to a height of about 82 mm as shown in FIG. 13.

### Fibrous Structure Example 3

A pre-moistened wipe according to the present invention is prepared as follows. A fibrous structure of the present invention generally made as described above in the second non-limiting process example exhibits a basis weight of about 65 g/m² and comprises a thermal bond pattern as shown in FIG. 12 is saturation loaded with a liquid composition according to the present invention to an average saturation loading of about 347% of the basis weight of the wipe. The wipes are then Z-folded and placed in a stack to a height of about 82 mm as shown in FIG. 13.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A co-formed fibrous structure comprising:
(a) a plurality of filaments having a biobased content of at least about 25% and selected from the group consisting of polypropylene, polyethylene, polymethylpentene, polybutene-1, polyisobutylene, ethylene propylene copolymer, and mixtures thereof; and,
(b) a solid additive comprising a cellulosic fiber;
wherein the solid additive is present in an amount of at least about 30 wt. %, based on the total weight of the fibrous structure.

2. The co-formed fibrous structure of claim 1, wherein the solid additive further comprises a compound selected from the group consisting of a granular substance, a powder, and mixtures thereof.

3. The co-formed fibrous structure of claim 1, wherein the plurality of filaments has a biobased content of at least about 50%.

4. The co-formed fibrous structure of claim 1, wherein the plurality of filaments has a biobased content of at least about 90%.

5. The co-formed fibrous structure of claim 1, wherein at least one filament is polypropylene.

6. The co-formed fibrous structure of claim 1, wherein at least one filament is a bicomponent filament.

7. The co-formed fibrous structure of claim 1, wherein at least one filament comprises a surfactant that is present in an amount of up to about 20 wt. %, based on the total filament weight.

8. The co-formed fibrous structure of claim 1, wherein the cellulosic fiber is derived from at least one of a mechanical pulp, a thermomechanical pulp, a chemithermomechanical pulp, a chemical pulp, a recycled pulp, bagasse, grass, and grain.

9. The co-formed fibrous structure of claim 1, wherein the cellulosic fiber is selected from the group consisting of a softwood pulp fiber, a hardwood pulp fiber, a groundwood pulp fiber, a cotton linter fiber, a sulfite pulp fiber, a sulfate pulp fiber, a rayon fiber, a lyocell fiber, and mixtures thereof.

10. The co-formed fibrous structure of claim 1, wherein the cellulosic fiber is selected from the group consisting of a Southern Softwood Kraft pulp fiber, a Northern Softwood Kraft pulp fiber, a Eucalyptus pulp fiber, an Acacia pulp fiber, and mixtures thereof.

11. The co-formed fibrous structure of claim 1 further comprising a secondary additive present in an amount of about 0.01 wt. % to about 95 wt. %, based on the total dry weight of the fibrous structure.

12. The co-formed fibrous structure of claim 11, wherein the secondary additive is selected from the group consisting of a softening agent, a bulk softening agent, a lotion, a silicone, a latex, a surface-pattern-applied latex, a dry strength agent, a temporary wet strength agent, a permanent wet strength agent, a wetting agent, a lint reducing agent, an opacity increasing agent, an odor absorbing agent, a perfume, a temperature indicating agent, a color agent, a dye, an osmotic material, a microbial growth detection agent, an antibacterial agent, and mixtures thereof.

13. The co-formed fibrous structure of claim 1, wherein the fibrous structure exhibits a pore volume distribution and greater than 40% of the total pore volume present in the fibrous structure exists in pores of radii of about 121 μm to about 200 μm.

14. The co-formed fibrous structure of claim 13, wherein the fibrous structure exhibits at least a bi-modal pore volume distribution and greater than about 2% of the total pore volume exists in pores of radii of less than 100 μm.

15. The co-formed fibrous structure of claim 1, wherein the fibrous structure exhibits a pore volume distribution and greater than 50% of the total pore volume present in the fibrous structure exists in pores of radii of about 101 μm to about 200 μm.

16. The co-formed fibrous structure of claim 1, wherein the fibrous structure is embossed, printed, tuft-generated, thermally bonded, ultrasonic bonded, perforated, surface treated, or combinations thereof.

17. The co-formed fibrous structure of claim 1, wherein the fibrous structure is selected from the group consisting of an absorbent pad, a paper, and a fabric.

18. The co-formed fibrous structure of claim 17, wherein the absorbent pad is selected from the group consisting of a sanitary tissue, a sanitary napkin, a diaper, and a wipe.

19. The co-formed fibrous structure of claim 18, wherein the sanitary tissue is selected from the group consisting of a toilet tissue, a facial tissue, and an absorbent towel.

20. A wet wipe comprising a co-formed fibrous structure according to claim 1.
